(19) United States
(12) Patent Application Publication
(10) Pub. No.: US 2025/0148428 A1
(43) Pub. Date: May 8, 2025

(54) CREATION OF WORKSITE DATA RECORDS VIA CONTEXT-ENHANCED USER DICTATION

(71) Applicant: Weavix, Inc., Wichita, KS (US)

(72) Inventors: Kevin TURPIN, Wichita, KS (US); Benjamin BURRUS, Wichita, KS (US)

(21) Appl. No.: 18/938,774

(22) Filed: Nov. 6, 2024

Related U.S. Application Data
(60) Provisional application No. 63/596,883, filed on Nov. 7, 2023.

(51) Int. Cl. G06Q 10/20; G06Q 10/0631; H04W 4/021; H04W 4/029

(52) U.S. Cl. CPC G06Q 10/20; G06Q 10/063114; H04W 4/021; H04W 4/029

(57) ABSTRACT

An apparatus (e.g., smart radio) carried by a worker includes a location tracking and/or machine-to-machine communication component. Via these features, a user of the apparatus receives information related to nearby equipment, machinery, structures, or components located throughout a worksite. The apparatus further includes a microphone, enabling the user to dictate tasks, updates, or requests based on this information. The apparatus automatically generates and/or updates data records from these dictations and uses context, including the information received by the user, to improve the data records. For example, semantic gaps or abstractions, such as this machine, in the user's dictations are more specifically defined or identified in a data record based the context, such as the user being located nearby a particular machine that the user is likely referring to when dictating this machine. As such, manual efforts and human errors associated with data record creation can be minimized, in some examples.

### CROSS-REFERENCE TO RELATED APPLICATIONS

This application claims the benefit of U.S. Provisional Patent Application Ser. No. 63/596,883, filed Nov. 7, 2023, which is incorporated by reference herein in its entirety.

### BACKGROUND

Traditional methods to monitor facilities are used to perform inspections in particular environments. Identifying issues with machinery is difficult. Typically, a frontline worker must manually inspect a machine or sensors in the machine and report to a central hub, which must dispatch a frontline worker to the machine. Where worksites are large, dispatch from a central hub can be highly inefficient. Frontline workers are typically disallowed from carrying smartphones, tablets, or portable computers on site. However, traditional methods and systems for communication within, and monitoring of, manufacturing and construction facilities sometimes have inadequate risk management and safeguards, lack an efficient structure, or can suffer from unrealistic risk management expectations or poor production forecasting.

Further, facility operation typically requires that these inspections and other work done (or needing to be done) by frontline workers in facilities be captured in data records. Existing efforts to capture real-life work performed in a facility can involve menial and prone-to-error data entry by the frontline workers or by others lacking first-hand contextual knowledge or information.

### BRIEF DESCRIPTION OF THE DRAWINGS

FIG. 1 is a block diagram illustrating an example architecture for a smart radio implementing example embodiments described herein.

FIG. 2 is a diagram illustrating an example environment for apparatuses and communication networks for worksites or facilities.

FIG. 3 is a drawing illustrating an example facility using apparatuses and communication networks for device location tracking and geofencing.

FIG. 4 is a flow diagram illustrating an example process for location-based auditory notifications associated with nearby equipment.

FIG. 5 is a diagram demonstrating location-responsive contextual notification and generation of workflow records.

FIG. 6 is a flow diagram illustrating an example process for location-responsive contextual notification and generation of workflow records.

FIG. 7 is a block diagram illustrating an example machine learning (ML) system.

FIG. 8 is a block diagram illustrating an example computer system for implementing example embodiments described herein.

### DETAILED DESCRIPTION

The present disclosure describes smart radios, systems, and methods for improving worker and task management in a facility or worksite. Example embodiments enable workers to abstractly dictate tasks, status updates or confirmations, requests, and/or the like, and semantic gaps in a worker's dictation are supplemented using contextual information surrounding the worker. Examples of contextual information that is detected and used to supplement worker dictation include (i) information relating to a machinery/equipment/structure/component that the worker is currently working on, (ii) presence and identification of proximate devices, (iii) communications transmitted to/from the worker's smart radio, (iv) a location or geofenced area of the worker within the facility, (v) immediately preceding behavior/actions of the worker, and more.

In one illustrative non-limiting example, a worker's smart radio audibly emits a status of a nearby machinery based on being located proximate to the nearby machinery, and in response, the worker utters a purchase order, a maintenance request, a status confirmation, or the like. The presently-disclosed technology reduces the burden on the worker to detail specific information in the worker's utterance. For example, the worker can simply utter We need to buy Component A for that machinery, someone needs to come fix that machinery, or I've inspected and approve that machinery. A system automatically generates a data record for the worker's utterance, with the machinery being automatically identified or specified as the nearby machinery of which the worker's smart radio is aware.

With respect to the above-mentioned example dictation indicating a need for a purchase of Component A for an abstractly-identified machinery, the system generates a purchase order for Component A. The system specifically identifies the machinery based on the context of the worker, such as a location of the worker, a current task of the worker, and/or the like, and inserts an identification of the machinery in the purchase order. While the user has generally dictated the primary information (e.g., who, what, where, when) for the purchase order, the system further generates formal or administrative information for the purchase order and/or performs post-generation operations with the purchase order. For example, the system automatically selects a purchasing manager to whom the system sends the purchase order, also based on the context of the worker, such as the worker's role, a worker's employer, a worker's location in a certain facility area, and/or the like. As another example, the system automatically retrieves data logs (e.g., sensor logs) associated with the identified machinery and includes the data logs with the purchase order.

Similar to this example purchase order, the system generates and/or updates data records such as work orders or requests. In response to the worker dictating someone needs to come fix that machinery as discussed above, the system generates a work order while specifically identifying the abstractly-mentioned machinery. In some examples, the system further selects a worker to task with fulfilling the work order or request. Again, using the worker's context, including the worker's location, the worker's role, and more, the system is able to select a worker with the same employer, a worker experienced with the identified machinery, and/or the like.

As exemplified above, the worker's dictation indicates a status update or confirmation, which can relate to an existing data record. For example, the worker dictates I've inspected and approve that machinery as the worker is working to fulfill an existing work order/request. As such, using the worker's context, the system identifies the abstractly-mentioned machinery and identifies the existing data record to update accordingly. In this and other examples, the system includes a direct transcription or a recording of the worker's dictation with the generated or updated data record.

As exemplified above, a system leverages the worker's surrounding context to de-abstract-ify portions of the worker's dictation and to further determine fields or parameters of the data record, for example, including formal or administrative information. Data record fields and parameters traditionally require menial, manual, and prone-to-error effort by a user to enter. By determining at least the formal or administrative information required for data records, such as task/project codes, supervisor contacts, worker location, and more, example systems disclosed herein reduce effort and errors by workers traditionally required to manually generate extensive data records.

In some embodiments, contextual information for a worker is collected according to a location of the worker (or precisely, a location of the worker's smart radio), which can be detected via different means. In some examples, a proximate device (e.g., a tag/sensor unit affixed to an equipment) detects the worker's smart radio and communicates both a location of the worker's smart radio and contextual information relating to itself to a system for data record creation. In some examples, a system tracks a location of the worker's smart radio over time via network nodes, such as cell towers, located throughout a facility or worksite and cross-references or identifies other devices/equipment near the location of the worker's smart radio to obtain contextual information. In some examples, a worker's smart radio reports its location based on location estimates by a Global Navigation Satellite System (GNSS) or Global Positioning System (GPS) component included within the worker's smart radio. Therefore, a system is able to determine a smart radio location via a variety of means, and some of these means themselves (e.g., proximate tags/sensor units) provide the contextual information used to enhance data record creation.

Further means of collecting/determining a context of a user is the user communications involving the worker via the worker's smart radio. A worker's recent communications with other workers, supervisors, and/or the like may have prompted or triggered the worker's dictation, and at a minimum, these recent communications are more than likely relevant to the worker's dictation. In some examples, a system identifies a purchasing manager, a supervisor, or other authority that needs to be identified in a data record using the worker's recent communications, including direct communications (e.g., radio and/or PTT audio streaming), text messaging in groups/threads/channels, and/or the like.

Embodiments disclosed herein further describe methods, apparatuses, and systems for device tracking and machine interfaces. Construction, manufacturing, repair, utility, resource extraction and generation, and healthcare industries, among others, rely on real-time monitoring and tracking of frontline workers, individuals, inventory, and assets such as infrastructure and equipment. In some embodiments, a portable and/or wearable apparatus, such as a smart radio, a smart camera, or a smart environmental sensor records information, downloads information, or communicates with other apparatuses and/or equipment. Some embodiments of the present disclosure provide lightweight and low-power apparatuses that are worn or carried by a worker and used to monitor information in the field or track the worker, at least for communication and equipment interface. The disclosed apparatuses provide alerts, locate resources for workers, and provide workers with access to communication networks. The wearable apparatuses disclosed enable worker compliance and provide assistance with operator tasks.

In some embodiments, the smart radio worn by workers receives communication from nearby machines and equipment. The communications cause the smart radio to emit status notifications and alerts regarding the nearby machine. For example, a sensor equipped to a boiler detects that the boiler is running hotter than specification. A frontline worker is passing by wearing a smart radio. As the worker passes by, the boiler communicates with the smart radio and causes the smart radio to emit an auditory notification: “Boiler #2 is running 10 degrees hotter than specification.” Rather than wait for a central hub to dispatch a worker, the worker passing by may inspect the boiler and implement any repairs or modifications to address the issue. Additionally, the worker did not have to notice the issue through any manual inspection; rather, the notification was sent while the worker was in the area. In some examples, these notifications are part of the context used to inform subsequent worker dictations; for example, this example boiler-radio communication can be used by a system to determine and insert a specific identifier for the boiler in a dictation-originated data record, or can be included as a note in the data record.

Disclosed smart radios enable workers to view other workers' credentials and roles such that participants know the level of expertise present. The systems further enable the location of workers who are currently out in the field using a facility map that is populated by information from smart radios, smart cameras, or smart sensors.

The smart radio embodiments disclosed that include Radio over Internet Protocol (RoIP) provide the ability to use an existing Land Mobile Radio (LMR) system for communication between workers, allowing a company to bridge the gap that occurs through the process of digitally transforming its systems. Communication is thus more open because legacy systems and modern apparatuses communicate with fewer barriers, the communication range is not limited by the radio infrastructure because the smart radios use the Internet, and costs are reduced for a company to provide communication apparatuses to their workforce by obviating more-expensive, legacy radios. The smart apparatuses enable workers to provide field observations to report safety issues in real time to drive operational performance. The apparatuses enable mass notifications to rapidly relay information to a specific subgroup, provide real-time updates for repair, and transmit accurate location pins.

The smart apparatuses disclosed reduce the need for workers to wear multiple, cumbersome, non-integrated, and potentially distractive devices into one user-friendly, comfortable, and cost-effective smart device. Advantages of the smart radio disclosed include case of use for carrying in the field during extended durations due to its smaller size, relatively low power consumption, and integrated power source. The smart radio is sized to be small and lightweight enough to be regularly worn by a worker. The modular design of the smart radio disclosed enables quick repair, refurbishment, or replacement.

Embodiments of the present disclosure will be described more thoroughly from now on with reference to the accompanying drawings. Like numerals represent like elements throughout the several figures in which example embodiments are shown. However, embodiments of the examples are embodied in many different forms and should not be construed as limited to the embodiments set forth herein. The examples set forth herein are non-limiting examples and are merely examples among other possible examples.

### Smart Radio

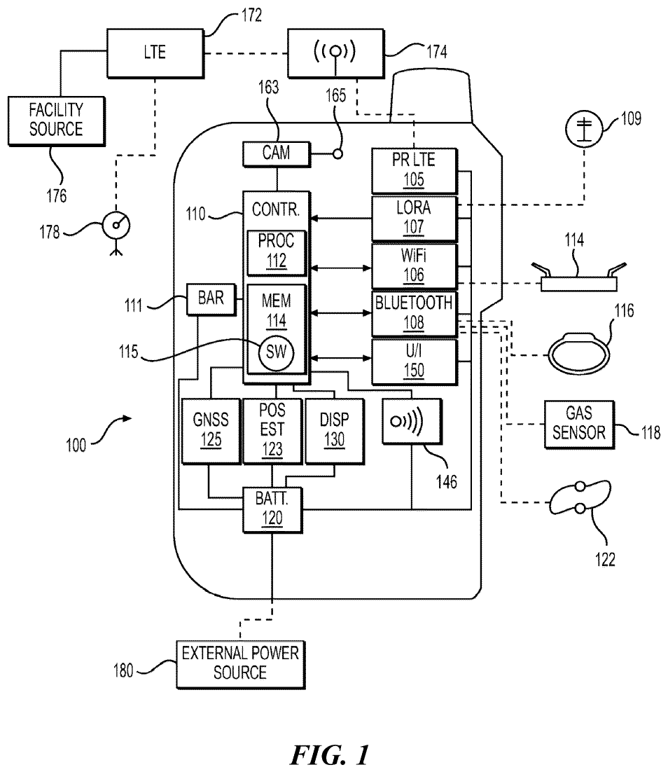

FIG. 1 is a block diagram illustrating an example architecture for an apparatus 100 that is implemented as a smart radio that improves worker operations in a facility or worksite. The present disclosure also refers to smart radios and smart apparatuses as smart walkie-talkies, two-way radio transceivers or two-way radio transceiver devices, communication handsets, shared communication devices, industrial radio devices, and/or the like. As will be understood by one of skill in the field of the present disclosure, a smart radio (or other disclosed terms) generally refers to a communication device for transmitting and receiving communication signals (e.g., radio signals) with other communication devices, such as other smart radios. More particularly, the present disclosure refers to a class of communication devices (including the smart radios, walkie-talkies, two-way transceiver devices, radio handsets as referred to throughout) that is understood as distinct from conventional consumer communication devices, such as smartphones (e.g., iPhones), tablets, media players, and the like. This class of communication devices, as represented by a walkie-talkie for example, is configured to provide communication capabilities in fields that require reliability, ruggedness, efficiency and/or low overhead in direct communication, and security. For example, walkie-talkies or two-way radio transceiver devices include specific features that are well-suited for use in an industrial workplace (e.g., a chemical plant, a manufacturing facility), in military field operations, in network-sparse locations, or in amateur/amusement activities. An example of such a feature present in walkie-talkies or two-way radio transceiver devices is a push-to-talk (PTT) key that improves the ability of a user to quickly communicate to another device via coarse user control (e.g., through gloved hands). Another example feature is a walkie-talkie having local on-device control or selection of its own operating channel (e.g., a radio frequency channel or band) that itself uses to communicate with other devices, thus offering flexibility without adherence to network-dictated channel schemes/allocations. While these features can realize the requirements associated with the aforementioned fields or settings, these same features can be absent in conventional consumer communication devices, which may also be inappropriate for those fields or settings due to fragility, due to distracting/irrelevant/extraneous user features, due to reliance on cellular network infrastructure, due to cost, and the like. Indeed, a smartphone device can lack such features, due to a lack of a need for a smartphone user to control (with specificity) the parameters of communication with other users. Through applied ingenuity and effort, unique and intelligent enhancements for this distinct class of communication devices and systems integrating the same have been developed (and are described herein) to improve the functionality and operation of these communication devices, while preserving their distinct applicability to certain fields or settings.

The apparatus 100 shown in FIG. 1 includes a controller 110 communicatively coupled electronically, either directly or indirectly, to a variety of wireless communication arrangements, a position estimating component 123 (e.g., a dead reckoning system) that estimates current position using inertia, speed, and intermittent known positions received from a position tracking component 125, which, in embodiments, is a Global Navigation Satellite System (GNSS) component, a display screen 130, an optional audio device 146, a user-input device 150, and a dual built-in camera 165 (another camera, 163 is on the other side of the device). A battery 120 is electrically coupled with a private Long-Term Evolution (LTE) wireless communication device 105, a Wi-Fi subsystem 106, a low-power wide area network (LPWAN), for example, long-range (LoRa) protocol subsystem 107, Bluetooth subsystem 108, barometer 111, audio device 146, user-input device 150, and built-in camera 163 for providing electrical power. Battery 120 is electrically and communicatively coupled with controller 110 for providing electrical power to controller 110 and enabling controller 110 to determine a status of battery 120 (e.g., a state of charge). In embodiments, battery 120 is a removable, rechargeable battery.

Controller 110 is, for example, a computer having a memory 114, including a non-transitory storage medium for storing software 115, and a processor 112 for executing instructions of the software 115. In some embodiments, controller 110 is a microcontroller, a microprocessor, an integrated circuit (IC), or a system-on-a-chip (SoC). Controller 110 includes at least one clock capable of providing time stamps and displaying time via display screen 130. The at least one clock is updatable (e.g., via the user interface 150, a global positioning system (GPS) navigational device, the position tracking component 125, the Wi-Fi subsystem 106, the LoRa subsystem 107, the server 176, or a combination thereof).

In embodiments, the apparatus 100 (e.g., implemented as a smart radio) communicates with a worker ID badge and a charging station using near-field communication (NFC) technology. An NFC-enabled device, such as a smart radio, also operates like an NFC tag or card, allowing a worker to perform transactions such as clocking in for the day at a worksite or facility, making payments, clocking out for the day, or logging in to a computer system of the facility. The smart radio communicates with the charging station using NFC in one or both directions.

Workers entering a facility carry or wear an identification (ID) badge that has an NFC tag (and optionally a radio frequency identification (RFID) tag) embedded in the badge. The NFC tag in the worker's ID badge stores personal information of the worker. Examples include name, employee or contractor serial number, login credentials, emergency contact(s), address, shifts, roles (e.g., crane operator), any other professional or personal information, or a combination thereof. When workers arrive for a shift, they pick a smart radio up off the charging station and tap their ID badge to the smart radio. The NFC tag in the ID badge communicates with an NFC module in the smart radio to log the worker into the smart radio and log/clock the worker into the workday.

Given that the workers' roles are “known” to the smart radio, communication with local machines is informed by those roles. For example, where the worker is emergency or medical staff, there is little point in alerting that worker to machine status messages. Conversely, a technician or machine operator would receive status notifications to relevant local machinery.

In some embodiments, when a smart radio is picked up off a charging station by a worker arriving at the facility, the smart radio operates as a time clock to record the start time for the worker at the facility. In some embodiments, the worker logs into the facility system using a touchscreen or buttons of the smart radio.

The cloud computing system 220 stores, manages, and updates shifts, contacts, and roles for each worker, project, and facility. A shift refers to a planned, set period of time during which the worker (optionally with a group of other workers) performs their duties. The worker has one or more roles (e.g., lathe operator, lift supervisor) for the same or different shifts. In some embodiments, the cloud computing system 220 keeps track of tools or equipment held by the worker (e.g., via Bluetooth tags on the equipment in proximity to the worn smart radio).

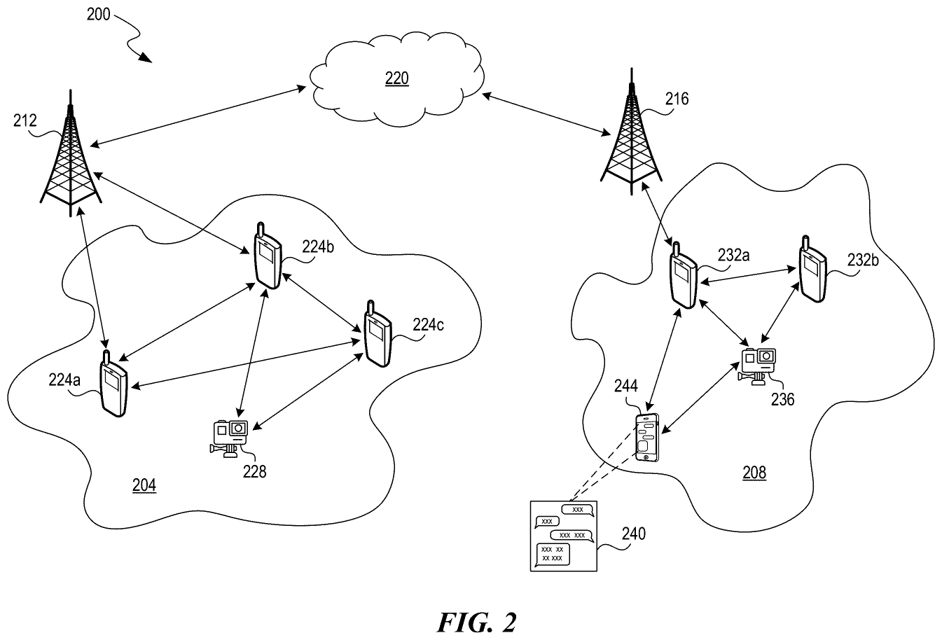

The cloud computing system 220 thus stores, manages, and updates shifts, contacts, and roles for each worker, project, and facility. The information is updated based in part on time logging information received from the smart radios and other smart apparatuses (as shown by FIG. 2). The cloud computing system 220 updates each smart radio with the information (on roles and contacts) needed for a shift when a worker clocks in using the radio.

In some embodiments, roles are assigned on a tiered basis. For example, Alice has roles assigned to her as an individual, as connected to the contract she is working, and as connected to her employer. Each of those tiers operates identity management within the cloud computing system 220. Each user frequently will work with others they have never met before and does not have the contact information thereto. Frontline workers tend to collaborate across employers or contracts. Based on tiered, assigned roles, the relevant contact information for workers on a given task/job is shared therebetween. “Contact information” as facilitated by the smart radio is governed by the user account in each smart radio (e.g., as opposed to a phone number connected to a cellular phone).

In embodiments, the smart radio and the cloud computing system 220 have geofencing capabilities. The smart radio allows the worker to clock in and out only when they are within a particular Internet geolocation. A geofence refers to a virtual perimeter for a real-world geographic area, (e.g., a portion of a facility). For example, a geofence is dynamically generated for the facility (as in a radius around a point location) or matched to a predefined set of boundaries (such as construction zones or refinery boundaries, or around specific equipment). A location-aware device (e.g., the position tracking component 125 and the position estimating component 123) of the smart radio entering or exiting a geofence triggers an alert to the smart radio, as well as messaging to a supervisor's device (e.g., the text messaging display 240 illustrated in FIG. 2), the cloud computing system 220, or a local server. The information, including a location and time, is sent to the cloud computing system 220. In embodiments, the machine learning system, illustrated and described in more detail with reference to subsequent figures, is used to trigger alerts, for example, using features based on equipment malfunctions or operational hazards as input data.

The wireless communications arrangement includes a cellular subsystem 105, a Wi-Fi subsystem 106, the optional LPWAN/LoRa network subsystem 107 wirelessly connected to a LPWAN network 109, and a Bluetooth subsystem 108, all enabling sending and receiving. Cellular subsystem 105, in embodiments, enables the apparatus 100 to communicate with at least one wireless antenna 174 located at a facility (e.g., a manufacturing facility, a refinery, or a construction site). For example, the wireless antennas 174 are permanently installed or temporarily deployed at the facility.

In embodiments, a cellular edge router arrangement 172 is provided for implementing a common wireless source. A cellular edge router arrangement 172 (sometimes referred to as an “edge kit”) is usable to include a wireless cellular network into the Internet. In embodiments, the LPWAN network 109, the wireless cellular network, or a local radio network is implemented as a local network for the facility usable by instances of the apparatus 100. For example, the cellular type can be 2G, 3G, 4G, LTE, 5G, etc. The edge kit 172 is typically located near a facility's primary Internet source 176 (e.g., a fiber backhaul or other similar device).

Alternatively, a local network of the facility is configured to connect to the Internet using signals from a satellite source, transceiver, or router 178, especially in a remotely located facility not having a backhaul source, or where a mobile arrangement not requiring a wired connection is desired. More specifically, the satellite source plus edge kit 172 is, in embodiments, configured into a vehicle or portable system. In embodiments, the cellular subsystem 105 is incorporated into a local or distributed cellular network operating on any of the existing 88 different Evolved Universal Mobile Telecommunications System Terrestrial Radio Access (EUTRA) operating bands (ranging from 700 MHz up to 2.7 GHZ). For example, the apparatus 100 can operate using a duplex mode implemented using time division duplexing (TDD) or frequency division duplexing (FDD).

The Wi-Fi subsystem 106 enables the apparatus 100 to communicate with an access point 114 capable of transmitting and receiving data wirelessly in a relatively high-frequency band. In embodiments, the Wi-Fi subsystem 106 is also used in testing the apparatus 100 prior to deployment. A Bluetooth subsystem 108 enables the apparatus 100 to communicate with a variety of peripheral devices, including a biometric interface device 116 and a gas/chemical detection device 118 used to detect noxious gases. In embodiments, the biometric and gas-detection devices 116 and 118 are alternatively integrated into the apparatus 100. In embodiments, numerous other Bluetooth devices are incorporated into the apparatus 100.

As used herein, the wireless subsystems of the apparatus 100 include any wireless technologies used by the apparatus 100 to communicate wirelessly (e.g., via radio waves) with other apparatuses in a facility (e.g., multiple sensors, a remote interface, etc.), and optionally with the cloud/Internet for accessing websites, databases, etc. The wireless subsystems 105, 106, and 108 are each configured to transmit/receive data in an appropriate format, for example, in Institute of Electrical and Electronics Engineers (IEEE) 802.11, 802.15, 802.16 Wi-Fi standards, Bluetooth standard, WinnForum Spectrum Access System (SAS) test specification (WINNF-TS-0065), and across a desired range. In embodiments, multiple apparatuses 100 are connected to provide data connectivity and data sharing across the multiple apparatuses 100. In embodiments, the shared connectivity is used to establish a mesh network.

The position tracking component 125 and the position estimating component 123 operate in concert. In embodiments, the position tracking component 125 is a GNSS (e.g., GPS) navigational device that receives information from satellites and determines a geographical position based on the received information. The position tracking component 125 is used to track the location of the apparatus 100. In embodiments, a geographic position is determined at regular intervals (e.g., every five seconds) and the position in between readings is estimated using the position estimating component 123.

GPS position data is stored in memory 114 and uploaded to server 170 at regular intervals (e.g., every minute). In embodiments, the intervals for recording and uploading GPS data are configurable. For example, if the apparatus 100 is stationary for a predetermined duration, the intervals are ignored or extended, and new location information is not stored or uploaded. If no connectivity exists for wirelessly communicating with server 170, location data is stored in memory 114 until connectivity is restored, at which time the data is uploaded, then deleted from memory 114. In embodiments, GPS data is used to determine latitude, longitude, altitude, speed, heading, and Greenwich mean time (GMT), for example, based on instructions of software 115 or based on external software (e.g., in connection with server 176). In embodiments, position information is used to monitor worker efficiency, overtime, compliance, and safety, as well as to verify time records and adherence to company policies.

In some embodiments, a Bluetooth tracking arrangement using beacons is used for position tracking and estimation. For example, Bluetooth component 108 receives signals from Bluetooth Low Energy (BLE) beacons. The BLE beacons or tags are located about the facility, for example, affixed to equipment, hardware units, machinery, structures, and/or the like. The controller 110 is programmed to execute relational distancing software using beacon signals (e.g., triangulating between beacon distance information) to determine the position of the apparatus 100. Regardless of the process, the Bluetooth component 108 detects the beacon signals and the controller 110 determines the distances used in estimating the location of the apparatus 100.

In alternative embodiments, the apparatus 100 uses Ultra-Wideband (UWB) technology with spaced apart beacons for position tracking and estimation. The beacons are small, battery-powered sensors that are spaced apart in the facility and broadcast signals received by a UWB component included in the apparatus 100. A worker's position is monitored throughout the facility over time when the worker is carrying or wearing the apparatus 100. As described herein, location-sensing GNSS and estimating systems (e.g., the position tracking component 125 and the position estimating component 123) can be used to primarily determine a horizontal location. In embodiments, the barometer component is used to determine a height at which the apparatus 100 is located (or operate in concert with the GNSS to determine the height) using known vertical barometric pressures at the facility. With the addition of a sensed height, a full three-dimensional location is determined by the processor 112. Applications of the embodiments include determining if a worker is, for example, on stairs or a ladder, atop or elevated inside a vessel, or in other relevant locations.

An external power source 180 is optionally provided for recharging battery 120. In embodiments, the architecture of the apparatus 100 shown by FIG. 1 includes a connector that connects to the external power source 180.

In embodiments, display screen 130 is a touch screen implemented using a liquid-crystal display (LCD), an e-ink display, an organic light-emitting diode (OLED), or other digital display capable of displaying text and images. An example text messaging display 240 is illustrated in FIG. 2. In embodiments, display screen 130 uses a low-power display technology, such as an e-ink display, for reduced power consumption. Images displayed using display screen 130 include, but are not limited to, photographs, video, text, icons, symbols, flowcharts, instructions, cues, and warnings. For example, display screen 130 displays (e.g., by default) an identification-style photograph of an employee who is carrying the apparatus 100 such that the apparatus 100 replaces a traditional badge worn by the employee. In another example, step-by-step instructions for aiding a worker while performing a task are displayed via display screen 130. In embodiments, display screen 130 locks after a predetermined duration of inactivity by a worker to prevent accidental activation via user-input device 150.

The audio device 146 optionally includes at least one microphone (not shown) and a speaker for receiving and transmitting audible sounds, respectively. Although only one speaker is shown existing in the architecture drawing of FIG. 1, it should be understood that in an actual physical embodiment, multiple speakers (and also microphones used for the purpose of noise cancellation) are utilized such that the apparatus 100 can adequately receive and transmit audio. In embodiments, the speaker has an output around 105 dB to be loud enough to be heard by a worker in a noisy facility. The speaker adjusts to ambient noise, for example, as the audio device 146 or a circuit driving the speaker samples the ambient noise, and then increases a volume of the output audio from the speaker such that the volume is greater than the ambient noise (e.g., 5 dB louder). In embodiments, a worker speaks commands to the apparatus 100. The microphone of the audio device 146 receives the spoken sounds and transmits signals representative of the sounds to controller 110 for processing.

In embodiments, the audio device 146 disseminates audible information to the worker via the speaker and receives spoken sounds via the microphone(s). The audible information is generated by the apparatus 100 based on data or signals received by the apparatus 100 (e.g., the smart camera 228 illustrated and described in more detail with reference to FIG. 2) from the cloud computing system 220, an administrator, a nearby machine, or a local server. For example, the audible information includes instructions, reminders, cues, and/or warnings to the worker and is in the form of speech, bells, dings, whistles, music, or other attention-grabbing noises without departing from the scope hereof. In embodiments, one or more speakers of the apparatus 100 (e.g., the smart radio) are adapted to emit sounds from a front side, a back side, any of the other sides of the smart radio, or even multiple sides of the smart radio.

In some embodiments, the smart radio 100 pairs to nearby machines via a Bluetooth radio 108 and the machine transmits relevant data concerning the status and operation history of the machine. In some embodiments the Bluetooth radio 108 receives beacon signals from the nearby machinery via BLE protocol. These beacon signals are interpreted by the smart radio 100 and/or cloud computing system 220 as a number of predetermined notification types. Based on the notification type or data received through pairing, the smart radio 100 emits audible information to the worker via the speaker.

In some embodiments, machinery communicates directly with the cloud computing system 220, and using a cross-reference between the tracked location of a given smart radio 100, a known location of the machinery, status data of the machinery, and individual worker information (e.g., roles, current task, etc.), the cloud computing system 220 issues a notification to the smart radio 100 to emit audible information to the worker.

### Communication Network Features

FIG. 2 is a drawing illustrating an example environment 200 for apparatuses and communication networks for device tracking and geofencing, in accordance with one or more embodiments. The environment 200 includes a cloud computing system 220, cellular transmission towers 212, 216, and local networks 204, 208. Components of the environment 200 are implemented using components of the example computer system illustrated and described in more detail with reference to subsequent figures. Likewise, different embodiments of the apparatus 100 include different and/or additional components and are connected in different ways.

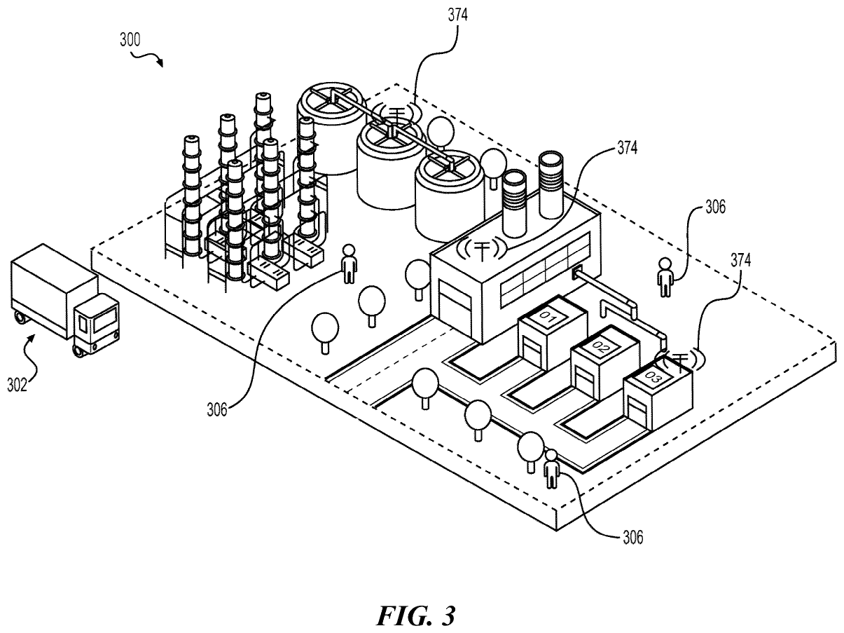

Smart radios 224, 232 and smart cameras 228, 236 are implemented in accordance with the architecture shown by FIG. 1. In embodiments, smart sensors implemented in accordance with the architecture shown by FIG. 1 are also connected to the local networks 204, 208 and mounted on a surface of a worksite, or worn or carried by workers. For example, the local network 204 is located at a first facility and the local network 208 is at a second facility. An example facility 300 is illustrated and described in more detail with reference to FIG. 3. In embodiments, each smart radio and other smart apparatus has two Subscriber Identity Module (SIM) cards, sometimes referred to as dual SIM. A SIM card is an IC intended to securely store an international mobile subscriber identity (IMSI) number and its related key, which are used to identify and authenticate subscribers on mobile telephony devices.

A first SIM card enables the smart radio 224a to connect to the local (e.g., cellular) network 204 and a second SIM card enables the smart radio 224a to connect to a commercial cellular tower (e.g., cellular tower 212) for access to mobile telephony, the Internet, and the cloud computing system 220 (e.g., to major participating networks such as Verizon™, AT&T™, T-Mobile™, or Sprint™). In such embodiments, the smart radio 224a has two radio transceivers, one for each SIM card. In other embodiments, the smart radio 224a has two active SIM cards, and the SIM cards both use only one radio transceiver. However, the two SIM cards are both active only as long as both are not in simultaneous use. As long as the SIM cards are both in standby mode, a voice call could be initiated on either one. However, once the call begins, the other SIM becomes inactive until the first SIM card is no longer actively used.

In embodiments, the local network 204 uses a private address space of IP addresses. In other embodiments, the local network 204 is a local radio-based network using peer-to-peer two-way radio (duplex communication) with extended range based on hops (e.g., from smart radio 224a to smart radio 224b to smart radio 224c). Hence, radio communication is transferred similarly to addressed packet-based data with packet switching by each smart radio or other smart apparatus on the path from source to destination. For example, each smart radio or other smart apparatus operates as a transmitter, receiver, or transceiver for the local network 204 to serve a facility. The smart apparatuses serve as multiple transmit/receive sites interconnected to achieve the range of coverage required by the facility. Further, the signals on the local networks 204, 208 are backhauled to a central switch for communication to the cellular towers 212, 216.

In embodiments (e.g., in more remote locations), the local network 204 is implemented by sending radio signals between smart radios 224. Such embodiments are implemented in less inhabited locations (e.g., wilderness) where workers are spread out over a larger work area that may be otherwise inaccessible to commercial cellular service. An example is where power company technicians are examining or otherwise working on power lines over larger distances that are often remote. The embodiments are implemented by transmitting radio signals from a smart radio 224a to other smart radios 224b, 224c on one or more frequency channels operating as a two-way radio. The radio messages sent include a header and a payload. Such broadcasting does not require a session or a connection between the devices. Data in the header is used by a receiving smart radio 224b to direct the “packet” to a destination (e.g., smart radio 224c). At the destination, the payload is extracted and played back by the smart radio 224c via the radio's speaker.

For example, the smart radio 224a broadcasts voice data using radio signals. Any other smart radio 224b within a range limit (e.g., 1 mile (mi), 2 mi, etc.) receives the radio signals. The radio data includes a header having the destination of the message (smart radio 224c). The radio message is decrypted/decoded and played back on only the destination smart radio 22c. If another smart radio 224b receives the radio signals that was not the destination radio, the smart radio 224b rebroadcasts the radio signals rather than decoding and playing them back on a speaker. The smart radios 224 are thus used as signal repeaters. The advantages and benefits of the embodiments disclosed herein include extending the range of two-way radios or smart radios 224 by implementing radio hopping between the radios.

In embodiments, the local network is implemented using RoIP. RoIP, is similar to Voice over IP (VOIP), but augments two-way radio communications rather than telephone calls. For example, RoIP is used to augment VOIP with PTT (Push-to-Talk). With RoIP, at least one node of a network is a radio (or a radio with an IP interface device, e.g., the smart radio 224a) connected via IP to other nodes (e.g., smart radios 224b, 224c) in the local network 204. The other nodes can be two-way radios but could also be softphone applications running on a smartphone (e.g., the smartphone 224, or some other communications device accessible over IP).

In embodiments, the local network 204 is implemented using Citizens Broadband Radio Service (CBRS). To enable CBRS, the controller 110 includes multiple computing and other devices, in addition to those depicted (e.g., multiple processing and memory components relating to signal handling, etc.). The controller 110 is illustrated and described in more detail with reference to FIG. 1. For example, the private network component 105 (illustrated and described in more detail with reference to FIG. 1) includes numerous components related to supporting cellular network connectivity (e.g., antenna arrangements and supporting processing equipment configured to enable CBRS). The use of CBRS Band 48 (from 3550 MHz to 3700 MHZ), in embodiments, provides numerous advantages. For example, the use of Band 48 provides longer signal ranges and smoother handovers. The use of CBRS Band 48 supports numerous smart radios 224 and smart camera 228 at the same time. A smart apparatus is therefore sometimes referred to as a Citizens Broadband Radio Service Device (CBSD).

In alternative embodiments, the Industrial, Scientific, and Medical (ISM) radio bands are used instead of CBRS Band 48. It should be noted that the particular frequency bands used in executing the processes herein could be different, and that the aspects of what is disclosed herein should not be limited to a particular frequency band unless otherwise specified (e.g., 4G-LTE or 5G bands could be used). In embodiments, the local network 204 is a private cellular (e.g., LTE) network operated specifically for the benefit of the facility. An example facility 300 implementing a private cellular network using wireless antennas 374 is illustrated and described in more detail with reference to FIG. 3. Only authorized users of the smart radios 224 have access to the local network 204. For example, the network 204 uses the 900 MHz spectrum. In another example, the local network 204 uses 900 MHz for voice and narrowband data for LMR communications, 900 MHz broadband for critical wide area, long-range data communications, and CBRS for ultra-fast coverage of smaller areas of the facility, such as substations, storage yards, and office spaces.

In embodiments, the communication systems disclosed herein mitigate the network bottleneck problem when larger groups of workers are working in or congregating in a localized area of the facility. When a large number of workers are gathered in one area, the smart radios 224 they carry or wear create too much demand for cellular networks or the cellular tower 212 to handle. To solve the problem, in embodiments, the cloud computing system 220 is configured to identify when a large number of smart radios 224 are located in proximity to each other.

In embodiments, the cloud computing system 220 anticipates where congestion is going to occur for the purpose of placing additional access points in the area. For example, the cloud computing system uses the ML system to predict where congestion is going to occur based on bottleneck history and previous location data for workers. An example of network chokepoints are facility entry points where multiple workers arrive in close succession and clock in. The cloud computing system 220 accounts for congestion at such entry points by including additional access points at such locations. The cloud computing system 220 configures each smart radio 224a to relay data in concert with the other smart radios 224b, 224c. By timing the transmissions of each smart radio 224a, the radio waves from the cellular tower 212 arrive at a desired location, i.e., the desired smart radio 224a, at a different point in time than the point in time the radio waves from the cellular tower 212 arrive at a different smart radio 224b. Simultaneously, the phased radio signals are overlaid to communicate with other smart radios 224c, mitigating the bottleneck.

The cloud computing system 220 delivers computing services-including servers, storage, databases, networking, software, analytics, and intelligence-over the Internet (“the cloud”) to offer faster innovation, flexible resources, and economies of scale. FIG. 2 depicts an exemplary high-level, cloud-centered network environment 200 otherwise known as a cloud-based system. Referring to FIG. 2, it can be seen that the environment centers around the cloud computing system 220 and the local networks 204, 208. Through the cloud computing system 220, multiple software systems are made to be accessible by multiple smart radio apparatuses 224, 232, smart cameras 228, 236, as well as more standard devices (e.g., a smartphone 244 or a tablet) each equipped with local networking and cellular wireless capabilities. Each of the apparatuses 224, 228, 244, although diverse, embody the architecture of apparatus 100 shown by FIG. 1, but are distributed to different kinds of users or mounted on surfaces of the facility. For example, the smart radio 224a is worn by employees or independently contracted workers at a facility. The CBRS-equipped smartphone 244 is utilized by an on or offsite supervisor. The smart camera 228 is utilized by an inspector or another person wanting to have improved display or other options. Regardless, it should be recognized that numerous apparatuses are utilized in combination with an established cellular network (e.g., CBRS Band 48 in embodiments) to provide the ability to access the cloud software applications from the apparatuses (e.g., smart radio apparatuses 224, 232, smart cameras 228, 236, smartphone 244).

In embodiments, the cloud computing system 220 and local networks 204, 208 are configured to send communications to the smart radios 224, 232 or smart cameras 228, 236 based on analysis conducted by the cloud computing system 220. The communications enable the smart radio 224 or smart camera 228 to receive warnings, etc., generated as a result of analysis conducted. The employee-worn smart radio 224a (and possibly other devices including the architecture of apparatus 100, such as the smart cameras 228, 236) are used along with the peripherals shown in FIG. 1 to accomplish a variety of objectives. For example, workers, in embodiments, are equipped with a Bluetooth enabled gas-detection smart sensor, implemented using the architecture shown in FIG. 1. The smart sensor detects the existence of a dangerous gas, or gas level. By connecting through the smart radio 224a or directly to the local network 204, the readings from the smart sensor are analyzed by the cloud computing system 220 to implement a course of action due to sensed characteristics of toxicity. The cloud computing system 220 sends an alert out to the smart radio 224 or smart camera 228, and thus a worker, for example, uses speaker 146 or alternative notification means to alert the worker so that they can avoid danger. The speaker 146 is illustrated and described in more detail with reference to FIG. 1.

### Machine-Defined Interactions

The cloud computing system 220 uses data received from the smart radio apparatuses 224, 232 and smart cameras 228, 236 to track and monitor machine-defined interactions and collaborations of workers based on locations worked, times worked, analysis of video received from the smart cameras 228, 236, etc. An “interaction” describes a type of work activity performed by the worker. An interaction is measured by the cloud computing system 220 in terms of at least one of a start time, a duration of the activity, an end time, an identity (e.g., serial number, employee number, name, seniority level, etc.) of the worker performing the activity, an identity of the equipment(s) used by the worker, or a location of the activity. In embodiments, an interaction is measured by the cloud computing system 220 in terms of a vector (e.g., [time period 1, equipment location 1; time period 2, equipment location 2; time period 3, equipment location 3]). For example, a first interaction describes time spent operating a particular machine (e.g., a lathe, a tractor, a boom lift, a forklift, a bulldozer, a skid steer loader, etc.), performing a particular task, or working at a particular type of facility (e.g., an oil refinery).

A smart radio 224a carried or worn by a worker would track that the position of the smart radio 224a is in proximity to or coincides with a position of the particular machine. Example tasks include operating a machine to stamp sheet metal parts for manufacturing side frames, doors, hoods, or roofs of automobiles, or welding, soldering, screwing, or gluing parts onto an automobile, all for a particular time period, etc. A lathe, lift, or other equipment would have sensors (e.g., smart camera 228 or other peripheral devices) that log times when the smart radio 224a is in proximity to the equipment and send that information to the cloud computing system 220.

In an example, a smart camera 228 mounted at a stamping shop in an automobile factory captures video of a worker working in the stamping shop and performs facial recognition or equipment recognition (e.g., using computer vision elements of the ML system illustrated and described in more detail with reference to subsequent figures). The smart camera 228 sends the start time, duration of the activity, end time, identity (e.g., serial number, employee number, name, seniority level, etc.) of the worker performing the activity, identity of the equipment(s) used by the worker, and location of the activity to the cloud computing system 220 for generation of one or more interaction(s).

The cloud computing system 220 also has a record of what a particular worker is supposed to be working on or is assigned to for the start time and duration of the activity. The cloud computing system 220 compares the interaction(s) computed with the planned shifts of the worker to signal mismatches, if any. An example interaction describes work performed at a particular geographic location (e.g., on an offshore oil rig or on a mountain at a particular altitude). The interaction is measured by the cloud computing system 220 in terms of at least the location of the activity and one of a duration of the activity, an identity of the worker performing the activity, or an identity of the equipment(s) used by the worker. In embodiments, the machine learning system is used to detect and track interactions, for example, by extracting features based on equipment types or manufacturing operation types as input data. For example, a smart sensor mounted on the oil rig transmits to and receives signals from a smart radio 224a carried or worn by a worker to log the time the worker spends at a portion of the oil rig.

A “collaboration” describes a type of group activity performed by a worker, for example, a group of construction workers working together in a team of two or more in an automobile paint facility, layering a chemical formula in a construction site for protection against corrosion and scratches, or installing an engine into a locomotive, etc. A collaboration is measured by the cloud computing system 220 in terms of at least one of a start time, a duration of the activity, an end time, identities (e.g., serial numbers, employee numbers, names, seniority levels, etc.) of the workers performing the activity, an identity of the equipment(s) used by the workers, or a location of the activity. In embodiments, a collaboration is measured by the cloud computing system 220 in terms of a vector (e.g., [time period 1, equipment location 1, worker identities 1; time period 2, equipment location 2, worker identities 2; time period 3, equipment location 3, worker identities 3]).

Collaborations are detected and monitored using location tracking (as described in more detail with reference to FIG. 1) of multiple smart apparatuses. For example, the cloud computing system 220 tracks and records a specific collaboration based on determining that two or more smart radios 224 were located in proximity to one another within a specific geofence associated with a particular worksite for a predetermined period of time. For example, a smart radio 224a transmits to and receives signals from other smart radios 224b, 224c carried or worn by other workers to log the time the worker spends working together in a team with the other workers.

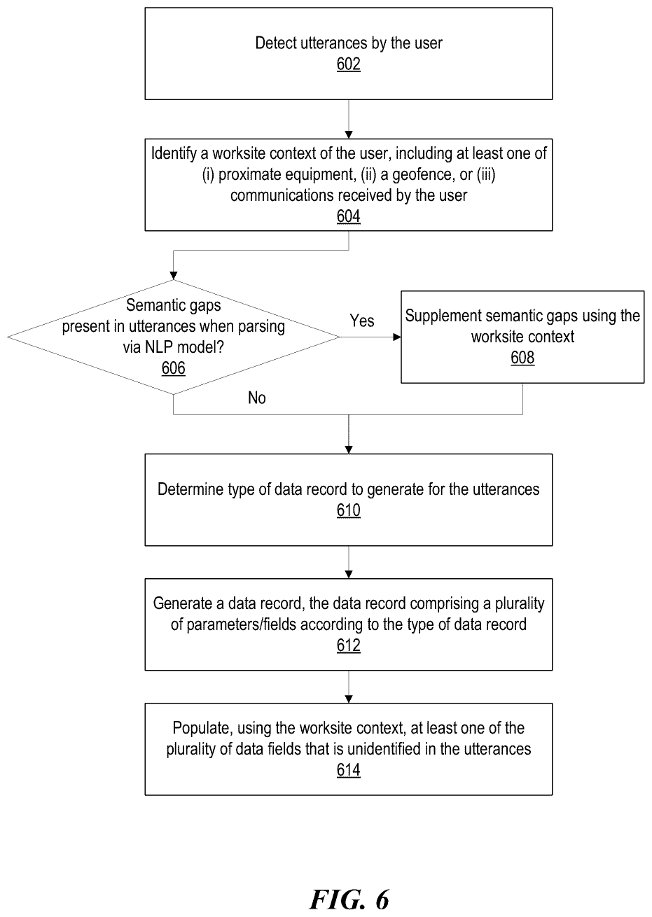

In embodiments, a smart camera 228 mounted at a paint facility captures video of the team working in the facility and performs facial recognition (e.g., using the ML system). The smart camera 228 sends the location information to the cloud computing system 220 for generation of collaborations. Examples of data downloaded to the smart radios 224 to enable monitoring of collaborations include software updates, device configurations (e.g., customized for a specific operator or geofence), location save interval, upload data interval, and a web application programming interface (API) server uniform resource locator (URL). In embodiments, the machine learning system (e.g., an example system illustrated and described with FIG. 6), is used to detect and track interactions (e.g., using features based on geographical locations or facility types as input data).

In embodiments, the cloud computing system 220 determines a “response time” metric for a worker. The response time refers to the time difference between receiving a call to report to a given task and the time of arriving at a geofence associated with the task. To determine the response time, the cloud computing system 220 obtains and analyzes the time the call to report to the given task was sent to a smart radio 224a of the worker from the cloud computing system 220, a local server, or a supervisor's device (e.g., smart radio 224b). The cloud computing system 220 obtains and analyzes the time it took the smart radio 224a to move from an initial location to a location associated with the geofence.

In some embodiments, the response time is compared against an expected time. Expected time is based on trips originating from a location near the starting location for the worker (e.g., from within a starting geofenced area, or a threshold distance) and ending at the geofence associated with the task, or a regional geofence that the task occurs within. Embodiments that make use of a machine learning model identify similar historical journeys as a basis of comparison.

In an example, the cloud computing system 220 determines a “repair metric” for a worker and a particular type of equipment (e.g., a power line, etc.) For example, a repair metric identifies how frequently repairs by a given individual were effective. Effectiveness of repairs is machine observable based on a length of time a given object remains functional as compared to an expected time of functionality (e.g., a day, a few months, a year, etc.). After a worker is called to repair a given object, a timer begins to run. The timer is ended by either of a predetermined period expiring (e.g., expected usable life of repairs) or an additional worker being called to repair that same object.

Thus, where a second worker is called out to fix the same object before the expected usable life of the repair has expired, the original worker is assumed to have done a poor job on the repair and their respective repair metric suffers. In contrast, so long as a second worker has not been called out to repair the same object (as evidenced by location data and dispatch descriptions) during the expected operational life of the repairs, the repair metric of the first worker remains positive. The expected operation life of a given set of repairs is based on the object repaired. In some embodiments, an ML model is used to identify appropriate functional lifetimes of repairs based on historical examples.

The repair metric is determined by the cloud computing system 220 in terms of at least one of locations of the worker (e.g., traveling to the equipment), location of the equipment, time spent in proximity to the equipment, predetermined amount of time the equipment is expected to be operable (e.g., a day, a few months, a year, etc.) after repair, number of repairs, etc.

In another example, a repair metric relates to an average amount of time equipment is operable and in working condition after the worker visits the particular type of equipment the worker repaired. The repair metric is determined by the cloud computing system 220 in terms of at least one of a location of a smart radio 224a carried by the worker, time spent in proximity to the equipment, predetermined amount of time the equipment is expected to be operable (e.g., a day, a few months, a year, etc.) after repair, or location of the equipment. For example, if the particular type of equipment is operable for more than 60 days after the worker visited the equipment (to repair it), the repair metric of the worker with respect to the particular type of equipment is increased. If the equipment has broken within less than a week after the worker visited the equipment (to repair it), the repair metric of the worker with respect to the particular type of equipment is decreased. In embodiments, the machine learning system, illustrated and described in more detail with reference subsequent figures, is used to detect and track interactions (e.g., using features based on equipment types or defect reports as input data).

Another example of a repair metric for a worker relates to a ratio of the amount of time an equipment is operable after repair to a predetermined amount of time the equipment is expected to be operable (e.g., a day, a few months, a year, etc.) after repair. The predetermined amount of time changes with the type of equipment. For example, some industrial components wear out in a few days, while other components can last for years. After the worker repairs the particular type of equipment, the cloud computing system 220 counts until the predetermined amount of time for the particular type of equipment is reached. Once the predetermined amount of time is met, the equipment is considered correctly repaired, and the repair metric for the worker is incremented. If before the predetermined amount of time another worker is called to repair the same equipment, the repair metric for the worker is decremented.

In embodiments, equipment is assumed/considered repaired until the cloud computing system 220 is informed otherwise. In such embodiments, the worker does not need to wait to receive credit to their repair metric in cases where the predetermined amount of time for particular equipment is large (e.g., months or years).

The smart radio 224a can track not only the current location of the worker, but also send information received from other apparatuses (e.g., the smart radio 224b, the camera 228) to contribute to the recorded locational information (e.g., of employees 306 at the facility 300 shown by FIG. 3). Because the smart radios 224 are readable by the cloud computing system 220, locational records can be analyzed to determine how well the different workers and other device users are doing in performing various tasks. For example, if a worker is inspecting a particular vessel in a refinery, it may be necessary for them to spend an hour doing so for a high-quality job to be performed. However, if the locational data record reveals that the worker was physically at the vessel for only two minutes, it would be an indication of hasty or incomplete work. The cloud computing system 220 can therefore track a “engagement metric” of time spent at a task with respect to the time required to be spent for the task to be performed.

In embodiments, the cloud computing system tracks the path chosen by a worker from a current location to a destination as compared to a computed direct path for determining “route efficiency.” For example, tracking records for multiple workers going from a contractor's building at the site to another point within the site can be used to determine efficiency (e.g., patterns in foot traffic). In an example, the tracking reveals that a worker chooses a pathway that causes them to go back and forth to a location on the site that is long and goes around many interfering structures. The added distances reduce cost-effectiveness because of where the worker is actually walking. Traffic patterns and the “route efficiency” of a worker monitored and determined by the cloud computing system 220 based on positional data obtained from the smart radios 224 is used to improve the worker's efficiency at the facility.

In embodiments, the tracking is used to determine whether one or more workers are passing through or spending time in dangerous or restricted areas of the facility. The tracking is used by the cloud computing system 220 to determine a “risk metric” of each worker. For example, the risk metric is incremented when time logged by a smart radio that the worker is wearing in proximity to hazardous locations increases. In embodiments, the risk metric triggers an alarm at an appropriate juncture. In another example, the facility or the cloud computing system 220 establishes geofences around unsafe working areas. Geofencing is described in more detail with reference to FIG. 1. The risk metric is incremented when the position of the smart radio is determined to be within the geofence even though the worker is not supposed to be within the geofence for the particular task. In another example, the risk metric is incremented when a position of the smart radio and sensors mounted on particular equipment indicate that the equipment is faulty or unsafe to use, yet the worker is using the equipment instead of signaling for replacement equipment to be provided. The logged position and other data are also used to generate records to build an evidence profile to be used in accident situations.

In embodiments, the established geofencing described herein enables the smart radio 224a to receive alerts transmitted by the cloud computing system 220. The alerts are transmitted only to the apparatuses worn by workers having a risk metric above a threshold in this example. Based on locational records of the apparatuses connected to the local network 204, particular movable structures within the refinery may be moved such that a layout is configured to reduce the risk metric for workers in the refinery (e.g., where the cloud computing system 220 detects that employees are habitually forced to take longer walk paths in order to get around an obstructing barrier or structure). In embodiments, the ML system is used to configure the layout to reduce the risk metric based on features extracted from coordinates of the geofencing, stored risk metrics, the locational records of the apparatuses connected to the local network 204, locations of the movable structures, or a combination thereof.

The cloud computing system 220 hosts the software functions to track operations, interactions, collaborations, and repair metrics (which are saved on one or more databases in the cloud) to determine performance metrics and time spent at different tasks and with different equipment and to generate work experience profiles of frontline workers based on interfacing between software suites of the cloud computing system 220 and the smart radio apparatuses 224, 232, smart cameras 228, 236, smartphone 244. The cloud computing system 220 is, in embodiments, configured by an administrating organization to enable workers to send and receive data to and from their smart devices. For example, functionality desired to create an interplay between the smart radios and other devices with software on the cloud computing system 220 is configured on the cloud by an organization interested in monitoring employees, transmitting alerts to these employees based on determinations made by a local server or the cloud computing system 220. Amazon Web Services (AWS), Microsoft Azure, and Google Cloud are widely used examples of a cloud platform, but others could be used instead.

Tracking of interactions, collaborations, and repair metrics is implemented in, for example, Scheduling Systems (SS), Field Data Management (FDS) systems, and/or Enterprise Resource Planning (ERP) software systems that are used to track and plan for the use of facility equipment and other resources. Manufacturing Management System (MMS) software is used to manage the production and logistics processes in manufacturing industries (e.g., for the purpose of reducing waste, improving maintenance processes and timing, etc.) Risk Based Inspection (RBI) software assists the facility using optimizing maintenance business processes to examine equipment and/or structures, and track interactions, collaborations, and repair metrics prior to and after a breakdown in equipment, detection of manufacturing failures, or detection of operational hazards (e.g., detection of gas leaks in the facility). The amount of time each worker logs at an interaction, collaboration, or other machine-defined activity with respect to different locations and different types of equipment is collected and used to update an “experience profile” of the worker on the cloud computing system 220 in real time. The repair metric and engagement metric for each worker with respect to different locations and different types of equipment is collected and used to update the experience profile of the worker on the cloud computing system 220 in real time.

FIG. 3 is a drawing illustrating an example facility 300 using apparatuses and communication networks for device tracking and geofencing, in accordance with one or more embodiments. For example, the facility 300 is a refinery, a manufacturing facility, a construction site, etc. An example apparatus 100 is illustrated and described in more detail with reference to FIG. 1. The communication technology shown by FIG. 3 is implemented using components of the example computer system illustrated and described in more detail with reference to subsequent figures.

Multiple differently and strategically placed wireless antennas 374 are used to receive signals from an Internet source (e.g., a fiber backhaul at the facility), or a mobile system (e.g., a truck 302). The wireless antennas 374 are similar to or the same as the wireless antenna 174 illustrated and described in more detail with reference to FIG. 1. The truck 302, in embodiments, includes the edge kit 172 illustrated and described in more detail with reference to FIG. 1. The strategically placed wireless antennas 374 repeat the signals received and sent from the edge kit 172 such that a private cellular network (e.g., the local network 204 illustrated and described in more detail with reference to FIG. 2) is made available to multiple workers 306. Each worker carries or wears a cellular-enabled smart radio. The smart radio is implemented using the apparatus 100 illustrated and described in more detail with reference to FIG. 1. As described in more detail with reference to FIG. 1 and FIG. 2, a position of the smart radio is continually tracked during a work shift.

In implementations, a stationary, temporary, or permanently installed cellular (e.g., LTE or 5G) source (e.g., edge kit 172) is used that obtains network access through a fiber or cable backhaul. In embodiments, a satellite or other Internet source is embodied into hand-carried or other mobile systems (e.g., a bag, box, or other portable arrangement). FIG. 3 shows that multiple wireless antennas 374 are installed at various locations throughout the facility. Where the edge kit 172 is located at a location near a facility fiber backhaul, the communication system in the facility 300 uses multiple omnidirectional Multi-Band Outdoor (MBO) antennas as shown. Where the Internet source is instead, located near an edge of the facility 300, as is often the case, the communication system uses one or more directional wireless antennas to improve the coverage in terms of bandwidth. Alternatively, where the edge kit is in a mobile vehicle, for example, truck 302, the antennas' directional configuration would be picked depending on whether the vehicle would ultimately be located at a central or boundary location.

In embodiments where a backhaul arrangement is installed at the facility 300, the edge kit 172 is directly connected to an existing fiber router, cable router, or any other source of Internet at the facility. In embodiments, the wireless antennas 374 are deployed at a location in which the apparatus 100 (e.g., a smart radio) is to be used. For example, the wireless antennas 374 are omnidirectional, directional, or semi-directional depending on the intended coverage area. In embodiments, the wireless antennas 374 support a local cellular network (e.g., the local network 204 illustrated and described in more detail with reference to FIG. 2). In embodiments, the local network is a private LTE network (e.g., based on 4G or 5G). In more specific embodiments, the network is a Band 48 CBRS local network. The frequency range for Band 48 extends from 3550 MHz to 3700 MHz and is executed using TDD as the duplex mode. The private LTE wireless communication device 105 (illustrated and described in more detail with reference to FIG. 1) is configured to operate in the private network created, for example, configured to accommodate Band 48 CBRS in the frequency range for Band 48 (again, from 3550 MHz to 3700 MHZ) and accommodates TDD. Thus, channels within the preferred range are used for different types of communications between the cloud and the local network.

### Location-Based Features

As described herein, smart radios are configured with location estimating capabilities and are used within a facility or worksite for which geofences are defined. A geofence refers to a virtual perimeter for a real-world geographic area, such as a portion of a facility or worksite. A smart radio includes location-aware devices (e.g., position tracking component 125, position estimating component 123) that inform of the location of the smart radio at various times. Embodiments described herein relate to location-based features for smart radios or smart apparatuses. Location-based features described herein use location data for smart radios to provide improved functionality. In some embodiments, a location of a smart radio (e.g., a position estimate) is assumed to be representative of a location of a worker using or associated with the smart radio. As such, embodiments described herein apply location data for smart radios to perform various functions for workers of a facility or worksite.

### Equipment Location Monitoring

Embodiments described herein relate to mobile equipment or tool tracking via smart radios as triangulation references. In this context, mobile equipment refers to worksite or facility industrial equipment (e.g., heavy machinery, precision tools, construction vehicles). According to example embodiments, a location of a mobile equipment is continuously monitored based on repeated triangulation from multiple smart radios located near the mobile equipment. Improvements to the operation and usage of the mobile equipment are made based on analyzing the locations of the mobile equipment throughout a facility or worksite. Locations of the mobile equipment are reported to owners of the mobile equipment or entities that own, operate, and/or maintain the mobile equipment. Mobile equipment whose location is tracked includes vehicles, tools used and shared by workers in different facility locations, toolkits and toolboxes, manufactured and/or packaged products, and/or the like. Generally, mobile equipment is movable between different locations within the facility or worksite at different points in time.

In some embodiments, a tag unit/device is physically attached to a mobile equipment so that the location of the mobile equipment is monitored. A computer system (e.g., example computer system, cloud computing system 220, a smart radio, an administrator smart radio) receives tag detection data from at least three smart radios based on the smart radios communicating with the tag device. Each instance of tag detection data received from a smart radio includes a distance to the tag device and a location of the smart radio.

In some embodiments, the tag detection data is received from smart radios owned or associated with different entities. That is, different smart radios that are not necessarily associated with the same given entity (e.g., a company with which various operators at the worksite are employed) as a given mobile equipment are used to track the given mobile equipment. As such, ubiquity of smart radios that are capable or allowed to track a given mobile equipment (via the tag device) is increased regardless of ownership or association with particular entities.

In some embodiments, the tag device is an AirTag™ device. In some embodiments, the tag device is associated with a detection range. The tag device is detectable via wireless communication by other devices, including smart radios, located within the detection range of the tag device. For example, a smart radio detects the tag device via Wi-Fi, Bluetooth, BLE, near-field communications, cellular communications, and/or the like. In some embodiments, a smart radio that is located within the detection range of the tag device detects the tag device, determines a distance between the smart radio and the tag device, and provides the tag detection data to the computer system.

From the tag detection data, the computer system determines a location of the tag device, which is representative of the location of the mobile equipment. In particular, the location of the mobile equipment is triangulated from the known locations of multiple smart radios and the respective distances to the tag device, using the tag detection data.

Thus, the computer system determines the location of the mobile equipment and is configured to continuously monitor the location of the mobile equipment as additional tag detection data is obtained over time.

In some embodiments, the determined location of the mobile equipment is indicated to the entity with which the mobile equipment is associated (e.g., an owner, a user of the mobile equipment, etc.). As discussed, in some examples, the location of the mobile equipment is determined based on triangulation of the tag device by different smart radios owned by different entities. If a mobile equipment location is determined via multiple entities, the mobile equipment location is only reported to the relevant entity, such that mobile equipment locations are not insecurely shared across entities.

In some embodiments, mobile equipment location is determined and tracked according to privacy layers or groups that are defined. For example, a tag for a mobile equipment is detected and tracked by a first group of entities (or smart radios assigned to a first privacy layer), and the determined location is reported to a smaller group of entities (or devices assigned to a second privacy layer).

Various monitoring operations are performed based on the locations of the mobile equipment that are determined over time. In some embodiments, a usage level for the mobile equipment is automatically classified based on different locations of the mobile equipment over time. For example, a mobile equipment having frequent changes in location within a window of time (e.g., different locations that are at least a threshold distance away from each other) is classified at a high usage level compared to a mobile equipment that remains in approximately the same location for the window of time. In some embodiments, certain mobile equipment classified with high usage levels are indicated and identified to maintenance workers such that usage-related failures or faults can be preemptively identified.

In some embodiments, a resting or storage location for the mobile equipment is determined based on the monitoring of the mobile equipment location. For example, an average spatial location is determined from the locations of the mobile equipment over time. A storage location based on the average spatial location is then indicated in a recommendation provided or displayed to an administrator or other entity that manages the facility or worksite.

In some embodiments, locations of multiple mobile equipment are monitored so that a particular mobile equipment is recommended for use to a worker during certain events or scenarios. As another example, for a worker assigned with a maintenance task at a location within a facility, one or more maintenance toolkits shared among workers and located near the location are recommended to the worker for use.

Accordingly, embodiments described herein provide local detection and monitoring of mobile equipment locations. Facility operation efficiency is improved based on the monitoring of mobile equipment locations and analysis of different mobile equipment locations.

The use of tags further enables the system to identify whether a given worker is carrying a given tool. Even with a single smart radio as a reference point, if a distance measurement remains static, and short (e.g., 3 feet or less) while the smart radio is tracked as moving, it is likely the worker is carrying the tool. Using the information that the worker is holding a particular tool is relevant to the sort of notifications or alerts presented to that worker.

Notifications Associated with Nearby Equipment

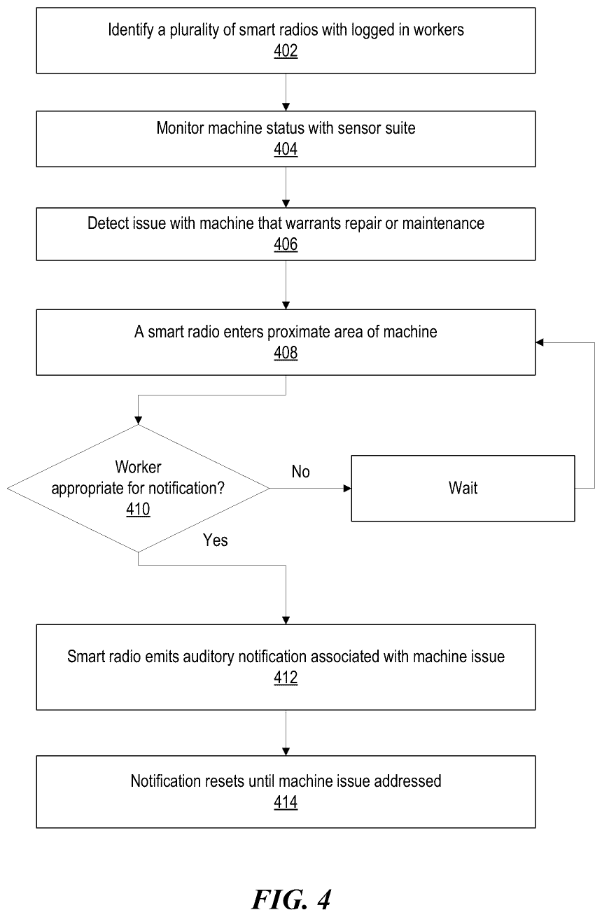

Turning now to FIG. 4, a flow diagram is provided. The flow diagram illustrates an example process for auditory notifications associated with nearby equipment. In some examples, the illustrated process is performed to minimize resource usage when communicating with workers in a facility about local scenarios and events. In some embodiments, the illustrated process is performed by a cloud computing system 220 (e.g., shown in FIG. 2). In some embodiments, the illustrated process is performed by a computer system, for example, the example computer system illustrated and described in more detail with reference to subsequent figures. Particular entities, for example, the smart radios (e.g., smart radios 405, smart radios 224), perform some or all of the steps of the process in some embodiments. Likewise, some embodiments include different and/or additional steps, or perform the steps in different orders.

In operation 402, a plurality of smart apparatuses (e.g., smart radios 405, smart radios 224) are carried by a worker and are location tracked. The worker is logged in to the smart radio. In some embodiments, the worker's role, work experience, and available tools are tracked by the smart radio. Available tools refer to tools that the system is aware that the worker is carrying or are available within a threshold distance. In some embodiments, the smart apparatuses are identified based on obtaining location and time logging information from multiple smart apparatuses. Locations of the multiple apparatuses are mapped to a plurality of geofences that define areas within a worksite.

In operation 404, a machine located somewhere within an operations facility is monitored by a sensor suite that identifies a status thereof. The machine includes a baseline or specification running condition. The sensor suite monitors the machine for anomalous and/or harmful conditions. In operation 406, the sensor suite detects an issue with the machine that would call for maintenance or repairs. For example, a given machine is low on lubricant, or another machine has become stuck or jammed. In some embodiments, the sensor suite reports the issue to the cloud computing system 220. In some embodiments, the issue is stored on a local register/memory.

In operation 408, the given smart apparatus passes by the machine that had detected an issue. The detection of the smart apparatus in the vicinity of the machine may vary by embodiment or implements multiple embodiments. An illustrative example of a detection method includes location tracking (ex: as described herein) cross-referenced with a known location of the machine by the cloud computing system or the smart apparatus. A further example makes use of short-range machine-to-machine communication techniques, such as Bluetooth or BLE. A BLE communication is a beacon that is receivable by any smart apparatus within range (adjustable by signal strength). A Bluetooth communication operates based on a pairing relationship between the smart apparatus and wireless transceiver apparatus of the machine. The relevant range is predetermined and based on settings that correspond to the method of detection. Short-range transmissions vary transmission power and location detection makes use of geofences or threshold distances.

In some embodiments, the ranges are based on a disambiguation range for the relevant machine. Disambiguation considerations are facility-specific and based on other neighboring machines of a similar type and sight lines thereto. Would a worker passing by be aware that an auditory notification referred to the relevant machine? Can the worker see the machine from the triggering distance? Are there other machines in the vicinity that the worker would confuse for the relevant machine?

For longer range embodiments, multiple devices may be present within range at the same time (e.g., as identified by a geofence). In such cases, notifications may be emitted by multiple smart apparatuses simultaneously to each user within a geofence or each user within a geofence who is not also within a threshold distance of another worker (e.g., to prevent redundant notification).

In operation 410, the system determines whether to notify the worker via auditory notification of the issue with the machine. In some embodiments, the notification occurs for each smart apparatus entering the predetermined range of the machine with the detected issue. In other embodiments, the system automatically evaluates one or more conditions prior to reporting. Example conditions include: does the worker holding the smart apparatus have a relevant role or work experience to address the particular issue that the sensor suite detected on the machine? Is the worker holding the necessary tool or set of tools that are required to address the issue? If not, are those tools within a threshold range and obtainable? Is the worker currently tasked with a priority task or a more important duty than addressing the machine's issue? Is the machine's issue an emergency?

To evaluate these conditions the system maintains a set of specifications that pertain to issues that the machine may experience. The specifications include flags related to the roles, skills, or personnel required to address each potential issue, and a priority level of the issue. These specifications are cross-referenced with the worker profile logged into the relevant, proximate smart apparatus and/or central dispatch records for each worker.

In operation 412, the smart apparatus emits an auditory notification to the worker carrying the smart apparatus. The auditory notification includes enough information for the worker to identify the relevant machine and the issue experienced by the machine (e.g., “the generator on your left needs oil”). In some embodiments, the notification further includes an instruction of where to find relevant tools or materials to address the issue (e.g., “oil is found in the cabinet opposite the generator”). The auditory notifications provide a speaker for the machine that wouldn't otherwise be able to communicate the issue to a worker passing by.

Communicating the issue to the worker while they are in the area achieves efficiencies in addressing issues while a worker is already in the area as opposed to requiring a worker sent from a central dispatch location to address the issue. Additionally, the speaker for the machine improves efficiency of a “wandering repairman” worker role. The wandering repairman need merely approach relevant machines rather than manually inspect the machines. If no notification is emitted by the worker's smart apparatus, the sensor suite did not detect an issue for that worker to repair or improve.

In some embodiments, additional constraints or thresholds are considered when selecting the subset of smart radios. For example, smart radios are assigned to different workers with different roles, role levels, profiles, and/or the like. Smart radios whose assigned worker satisfies a threshold role level, a role/profile requirement, and/or the like are considered for the selection of the subset. In some embodiments, the additional constraints (e.g., threshold role level, role requirement) are determined based on the relevant event or scenario that prompted the process.

In operation 414, it is contemplated that the first passing worker may not address the issue; thus, the machine issue resets or persists until addressed. In this manner, the next worker who passes by may receive the same auditory notification. Workers are notified until someone fixes the issue with the machine. When a worker engages with the machine they will report in a dispatch system to reset the sensor suite. In some embodiments, the dispatch system report or sensor suite reset occurs automatically based on proximity or new sensor suite readings.

In some embodiments, selection of smart radios is further based on experience profiles of the workers associated with the smart radios. For example, workers with an average response time less than a threshold are automatically selected for the first responder subset. Use of response time metrics in worker experience profiles conserves some time that would be spent detecting response activities on the smart radios and determining (and ordering) response times.

### Workflow Generation Via Context-Informed Dictation

Example embodiments of the present disclosure relate to generating and updating workflow records based on user dictations detected by smart radios. In some examples, the user dictations are prompted by contextual events, such as auditory notifications of equipment status or communications received at the smart radio, and these contextual events supply additional information used by a system to supplement semantic meaning in the user dictations and to generate formal and administrative information required to complete a data record for the user dictations. Beyond determining and inserting information aided by the user's context, the system is able to perform further operations with the data record, including automatically sending the data record for approval by another user, linking the data record with other related data records, and/or the like. These embodiments improve operational efficiency with data generation being automated or assisted by smart radio locations and contextual information associated therewith. In some examples, a worker using a smart radio spends less time on data entry and lookup tasks, and recorded information is more accurate and reliable with a likelihood of human error being reduced.

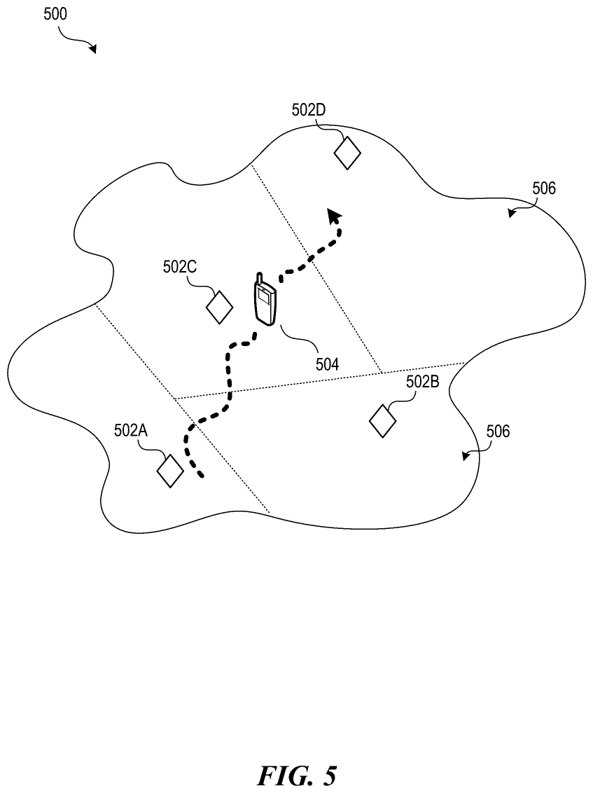

FIG. 5 illustrates a diagram of a facility or worksite 500 in which example embodiments are implemented. In particular, FIG. 5 demonstrates location determination of a smart radio 504 as used to determine contextual information for a worker. Proximate devices 502 are located throughout the worksite 500. The proximate devices 502 are systems, devices, or units that are configured to, when a smart radio is located nearby, detect a location of the smart radio, for example, based on a known location of the proximate devices 502. Alternatively, or additionally, a location of the smart radio within the worksite 500 is determined based on a GNSS/GPS component within the smart radio, based on network-based techniques (e.g., via network nodes or cell towers located throughout the worksite 500), and/or the like.

Further, as discussed above, the proximate devices cause contextual information, including equipment statuses, to be audibly emitted to the worker, thereby prompting/triggering the worker's dictation, in some examples. For example, the proximate devices 502 include the machinery or equipment described earlier, for which a smart radio can be a speaker for the machinery or equipment. In some examples, the proximate devices 502 are tag/sensor units affixed to machinery, equipment, structures, and/or the like in the worksite 500. The proximate devices 502 are affixed to a static location or are able to be located in different locations over time (e.g., affixed to mobile equipment).

In some embodiments, in response to a smart radio 504 being detected nearby a proximate device 502, the proximate device 502 provides contextual information to a user of the smart radio 504. In some embodiments, the smart radio 504 is detected near a proximate device 502 by the proximate device 502, for example, via peer-to-peer communications (e.g., Bluetooth or BLE, RFID), via sensors, and/or the like. In some embodiments, the smart radio 504 is detected near a proximate device 502 by a central system, such as the cloud computing system 220, which can notify the proximate device 502 that the smart radio 504 is nearby. In some embodiments, proximity of a smart radio 504 to a proximate device 502 begins at the smart radio 504; for example, the smart radio 504 can search for proximate devices 502 within a range therefrom and can trigger or wake up a proximate device 502 within the range to provide contextual information.

In some embodiments, the proximate device 502 provides the contextual information to the user of the smart radio 504 based on the smart radio 504 emitting to its user an auditory notification of the contextual information. In some examples, the proximate device 502 includes speakers, displays, and/or the like via which the proximate device 502 can directly communicate contextual information to a nearby smart radio user.

Example contextual information communicated to a user includes information related to a current status in time of co-located or nearby equipment, machinery, structures, and/or the like. For example, the contextual information is generated by sensor devices that monitor the equipment, machinery, structure, and/or the like. In some examples, such status information is simpler, such as a use count or a deployment duration, such that the proximate device 502 itself is able to determine the status information (e.g., by implementing a timer or counter). In some examples, the contextual information is related to a current task/role/workflow being performed by the smart radio user. For example, the smart radio user travels through the worksite 500 to gather parts for an assembly. Contextual information emitted/provided by a first proximate device 502A directs the worker to a second proximate device 502C, and so on (as demonstrated in FIG. 5, for example), thereby providing task-specific information.

In some embodiments, a proximate device 502 continues to provide contextual information to a smart radio user or worker while the smart radio user is located within a range proximate to the proximate device 502 (e.g., a disambiguation range). According to some embodiments, the contextual information continues to be provided to a worker (e.g., via smart radio audio, via smart radio display) persistently until the worker utters a dictation related to the contextual information, such as a work order or a tracking update. In this way, dictation ensures user attention to the contextual information and encourages prompt recording or capturing of contextual-based information (e.g., tasks, status updates). In some embodiments, persistence of the contextual information is based on a role of the smart radio user or worker. In such embodiments, dictation-controlled persistence can be implemented for senior-level workers or managers or workers having permission to generate workflows and requests.

As further illustrated in FIG. 5, the worksite 500 includes geofences 506 that (i) provide contextual information to workers that can prompt worker dictations, and/or (ii) represent a context of a worker used to enhance data record creation from the worker dictations. For example, similar to status notifications being provided to a worker based on the worker being nearby a proximate device, status notifications are provided to the worker based on the worker being located in a geofence 506. Examples of such geofence-controlled status notifications include temperature sensors in this area indicate abnormally-high outside temperatures, and only personnel with Contractor X are permitted in this area. These example notifications could respectively prompt a worker to dictate a request such as send maintenance to check the temperature sensors in this area and please update my profile to reflect my employment with Contractor X.

Later, a geofence 506 in which a worker is located when uttering a dictation represents the context for the worker, in some examples. The geofence 506 in which the worker is located is used to complete formal or administrative information required for a data record (e.g., a work/purchase order, a status/tracking report). If a geofence 506 is defined to only permit workers associated with Contractor X therewithin, a system automatically identifies Contractor X as a supervisor, bill paying authority, or the like for purchase orders, status confirmations, and the like dictated by the worker while within the geofence 506. As such, the worker does not need to complete those administration parameters or fields of a data record. Such geofence-controlled context is useful for workers who are performing different roles under different supervisors throughout the facility and may not recall later the capacity in which the worker needed a task to be performed or a purchase to be completed.

Turning now to FIG. 6, a flow diagram for context-enhanced creation of data records from user dictations is illustrated. In some embodiments, the example operations shown in FIG. 6 are performed by a smart radio. For example, the smart radio comprises at least one processor and a non-transitory computer-readable storage medium storing instructions that, when executed by the at least one processor, cause the smart radio to perform at least some of the example operations. In some embodiments, at least some of the example operations are performed by a computing device, which includes a central or remote system, such as the cloud computing system 220.

In operation 602, a system detects utterances by the user. In some examples, the utterances by the user are prompted by a notification (e.g., from a proximate device) or a communication (e.g., from a remote supervisor), and the utterances can pertain to the information indicated in the notification or communication. In one illustrative non-limiting example, an example utterance detected by the system is Item A is located here, or I've found Item A. In another illustrative non-limiting example, an example utterance by a user and detected by the system is We need to replace the battery for Machine B, or Please have Worker X inspect Machine B's battery. In yet another illustrative non-limiting example, the smart radio user utters Gauge reading looks nominal. In yet another illustrative non-limiting example, the system detects the user uttering I've finished inserting Widget C into Apparatus D. As shown, the smart radio user's utterance can include status updates, confirmatory statements, requests identifying future tasks, and/or the like, which can be prompted by notifications/communications received by the smart radio user, or actions/tasks completed by the smart radio user.

In some embodiments, the utterance is detected via a sound sensor or microphone included in the smart radio. The system detecting the user's utterances can be another device or system remote from the smart radio. For example, the smart radio streams audio signals detected via the sound sensor to another smart radio, a base or central station, the cloud computing system 220, and/or another computing device, which then identifies utterances in the streamed audio signals. In some embodiments, the utterance is detected during an interaction with a virtual assistant or artificial intelligence interface. A user will trigger a listening mode for the virtual assistant and the virtual assistant will route the utterance to the operation within the presently described method.

In operation 604, the system identifies a worksite context of the user. In some examples, the worksite context can include (i) proximate devices or equipment, (ii) a geofence, or (iii) communications received by the user. In some embodiments, the notification or communication (and information indicated therewithin) is part of the worksite context. Thus, by identifying the worksite context, the system is able to determine a cause, trigger, or reason for the user's utterance or dictation. Identification of the worksite context allows user utterances to be more abstract or implicit. For example, if the user utters Bob needs to come inspect this, the system infers that the identified proximate device providing the context notification that prompted this utterance (or a machinery located hereby) is being referred to by this. In another example, if the user utters per John's message, we should flag this equipment for inspection, the system references a communication received from John to identify the equipment for inspection. The system also identifies other communication-based context, including groups/threads/channels in which the user is a member or actively communicates.

Accordingly, in operation 606, the system determines whether there are semantic gaps in the utterances when parsing the utterances via an NLP model, and in operation 608, the system supplements any such semantic gaps using the worksite context. As exemplified above, semantic gaps can be implicit, abstract, or referential words or phrases included in the user's utterances, such as this, that, or here. In some embodiments, the semantic gaps specifically relate to a subject/object of a dictated task, a location of the dictated task, and/or a worker responsible for the dictated task. For example, the minimum information needed to create a data record for a task or request includes at least one of what, where, when, and who. In operation 606, the system attempts to determine each of what, where, when, and who, and supplements any implicit information relating thereto using the worksite context in operation 608. For example, if the worker abstractly mentions someone who should be responsible for fulfilling a dictated task, the system specifically identifies the someone based on the communication-based context of the worker.

In some embodiments, the NLP model is configured or trained to process the detected utterances, including detecting these semantic gaps. For example, the NLP model includes a classification function or module in which the NLP model classifies tokenized (and transcribed) portions of the utterances as being a semantic gap or not. In some examples, the NLP model is configured to classify/detect semantic gaps using a bank of known words that are implicit, abstract, or referential. In some examples, the NLP model is trained to classify/detect semantic gaps based on being trained on a dataset of words, at least some of which being labelled as implicit, abstract, or referential.

In some examples, the detected utterances do not include semantic gaps; for example, the user explicitly specifies at least the subject or object of a task. In such examples, the system proceeds to operation 610, as illustrated in FIG. 6. The system also proceeds to operation 610 after supplementing semantic gaps using the worksite context.

In operation 610, the system determines a type of data record to generate for the utterances. With any semantic gaps being accounted for, the system more accurately ascertains the nature of the user's utterance, whether it be a purchase request, a work order, a status/tracking update or report, or the like. In some embodiments, the system further uses the NLP model to determine this nature of the utterances in order to determine what type of data record to create. For example, the NLP model is configured or trained to provide a likelihood that the user's utterances indicate a request for a future action (e.g., a purchase, an inspection) or a confirmation of a current state or previous task.

In operation 612, the system generates a workflow record and/or updates an existing workflow record. In some embodiments, whether the system generates a new record or updates an existing record can depend on the nature of the utterance, the context notification, or a current task (if any) of the smart radio user. For example, if the user utters We need to order a new part for Machine E, the system generates a new record (e.g., a work order, a purchase order). Whereas if the user utters I confirm this sensor reading is still in acceptable range, the system updates an existing workflow record that includes inspection tasks.

The system generates/updates the workflow record based on parsing and processing/analyzing the utterances via an NLP model, for example, to extract semantic meaning from the utterances. In some embodiments, the NLP model is configured or trained to identify tasks, confirmations, requests, or other relevant information within the utterances and provides a set of the identified tasks or the like. In some embodiments, the NLP model is or comprises a machine-learning model that determines a likelihood that an utterance (or a tokenized portion thereof) is a task/confirmation/request, and classifies the utterance accordingly.

In operation 614, the system populates at least one of a plurality of data fields of the data record using the worksite context. The data record includes data fields or parameters according to the type of data record. For example, data records for a purchase order include a data field or parameter for identifying a bill paying authority or purchasing entity. These data fields or parameters provide auxiliary, formal, or administrative information in support of the primary information indicated by the data record, and completion of such auxiliary or administrative information constitutes a large portion of the time-consuming and menial nature of data record creation. Accordingly, the system populates this information, typically unidentified in the utterances, also using the worksite context. As such, the user is able to focus his or her brief utterances more on the critical information for the data record (e.g., what needs to be repaired, where the repair needs to happen, who needs to perform the repair), and the user leaves the formal information to be completed by the system. Examples of formal or administrative information populated by the system include purchasing entity, project/task code or identifier, datetime, and/or the like.

Thus, from a relatively short or simple dictation by a worker, a system is able to generate a complete or near-complete data record. According to examples discussed herein, a system is able to generate a purchase order that specifies a component to be purchased, a machinery/equipment to which the component belongs, a location of the machinery/equipment, a purchasing or paying authority or supervisor, and/or the like. At least one of these parameters or fields may be at least abstractly described by a worker's dictation, and in some examples, all of these parameters or fields are populated by the system using the worker's context. As another example, a system is able to generate a work order or task request that is complete or near-complete beyond what is explicitly and implicitly described in a worker's dictation. An example of such a work order or task request specifies the task or operation to be performed, a machinery/equipment for which the task or operation is performed, a worker to fulfill the task or operation (or at least requirements or qualifications needed for a worker to fulfill the task or operation), a location of the task or operation, and/or the like. Again, at least one of these parameters or fields may be mentioned by a worker's dictation, and in some examples, all of these parameters or fields are determined by a system using worker context where necessary.

Referring to other examples discussed herein, the system is able to update an existing data record to a complete or near-complete state. In response to a worker's dictation that is determined to be an update or a confirmation, the system populates data fields of an existing data record that were previously left empty pending fulfillment/completion of a task/operation. For example, an existing data record for a specified task includes empty fields specifying a time of completion, a worker identifier for a worker completing the specified task, a location of completion, a supervisor approval, and data logs proving the completion of the specified task. A system is able to complete these empty fields in response to a worker's dictation and further using a context of the user. For example, a system is able to identify and retrieve the correct or relevant data logs to be attached to the existing data record, based on the context of the user identifying sensors located nearby the user or oriented towards a machinery on which the specified task was performed.

Therefore, the system automatically includes information associated with the identified proximate devices (or items, machinery, equipment, structures related thereto) in the workflow record. As discussed above, the system supplements implicit gaps or abstractions in the user's utterances by the automatic inclusion of said information. Example information automatically included by the system in a workflow record includes equipment/item identifiers, proximate device location/geofence/area, and/or the like. Other formal or administrative information is included in the data record by the system, including task history associated with the proximate device, identification of purchasers, and/or the like. In some embodiments, the workflow record also identifies specific workers or worker roles that are mentioned in the user's utterances, selected based on the context notification and/or the identification of the proximate devices, inferred based on semantic information included in the user's utterances, and/or the like.

In some embodiments, the system associates the workflow record with the proximate device or the equipment/devices/etc. related thereto. In doing so, in some examples, the workflow record is indicated in subsequent context notifications provided to users (e.g., battery level low, see pending record 123). Alternatively, or additionally, the workflow record is provided by a smart radio at which a specific worker or a worker with a specific role identified in the workflow is logged-in.

### Example Computer Embodiments

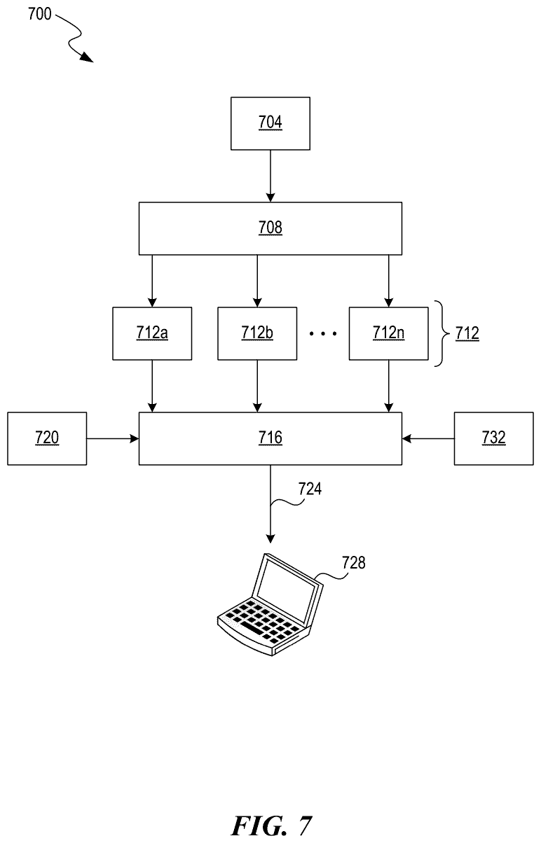

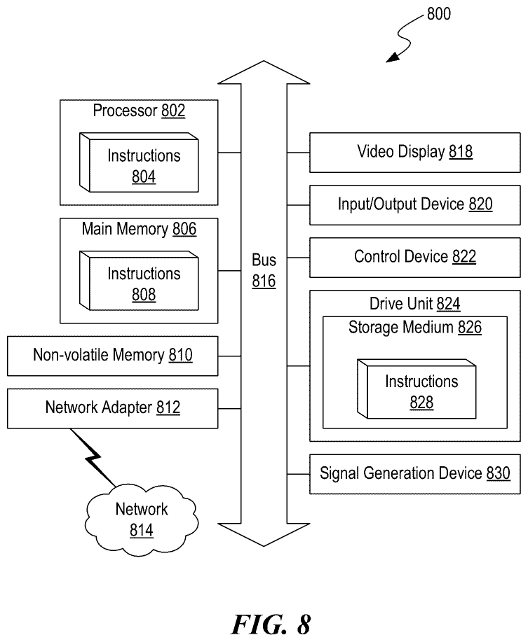

FIG. 7 is a block diagram illustrating an example ML system 700, in accordance with one or more embodiments. The ML system 700 is implemented using components of the example computer system 800 illustrated and described in more detail with reference to FIG. 8. For example, portions of the ML system 700 are implemented on the apparatus 100 illustrated and described in more detail with reference to FIG. 1, or on the cloud computing system 220 illustrated and described in more detail with reference to FIG. 2. Likewise, different embodiments of the ML system 700 include different and/or additional components and are connected in different ways. The ML system 700 is sometimes referred to as a ML module.

The ML system 700 includes a feature extraction module 708 implemented using components of the example computer system 800 illustrated and described in more detail with reference to FIG. 8. In some embodiments, the feature extraction module 708 extracts a feature vector 712 from input data 704. For example, the input data 704 includes location parameters measured according to example embodiments described herein. The feature vector 712 includes features 712a, 712b, . . . , 712n. The feature extraction module 708 reduces the redundancy in the input data 704, for example, repetitive data values, to transform the input data 704 into the reduced set of features 712, for example, features 712a, 712b, . . . , 712n. The feature vector 712 contains the relevant information from the input data 704, such that events or data value thresholds of interest are identified by the ML model 716 by using a reduced representation. In some example embodiments, the following dimensionality reduction techniques are used by the feature extraction module 708: independent component analysis, Isomap, kernel principal component analysis (PCA), latent semantic analysis, partial least squares, PCA, multifactor dimensionality reduction, nonlinear dimensionality reduction, multilinear PCA, multilinear subspace learning, semidefinite embedding, autoencoder, and deep feature synthesis.

In alternate embodiments, the ML model 716 performs deep learning (also known as deep structured learning or hierarchical learning) directly on the input data 704 to learn data representations, as opposed to using task-specific algorithms. In deep learning, no explicit feature extraction is performed; the features 712 are implicitly extracted by the ML system 700. For example, the ML model 716 uses a cascade of multiple layers of nonlinear processing units for implicit feature extraction and transformation. Each successive layer uses the output from the previous layer as input. The ML model 716 thus learns in supervised (e.g., classification) and/or unsupervised (e.g., pattern analysis) modes. The ML model 716 learns multiple levels of representations that correspond to different levels of abstraction, wherein the different levels form a hierarchy of concepts. The multiple levels of representation configure the ML model 716 to differentiate features of interest from background features.

In alternative example embodiments, the ML model 716, for example, in the form of a CNN generates the output 724, without the need for feature extraction, directly from the input data 704. The output 724 is provided to the computer device 728, the cloud computing system 220, or the apparatus 100. The computer device 728 is a server, computer, tablet, smartphone, smart speaker, etc., implemented using components of the example computer system 800 illustrated and described in more detail with reference to FIG. 8. In some embodiments, the steps performed by the ML system 700 are stored in memory on the computer device 728 for execution. In other embodiments, the output 724 is displayed on the apparatus 100 or electronic displays of the cloud computing system 70.

A CNN is a type of feed-forward artificial neural network in which the connectivity pattern between its neurons is inspired by the organization of a visual cortex. Individual cortical neurons respond to stimuli in a restricted area of space known as the receptive field. The receptive fields of different neurons partially overlap such that they tile the visual field. The response of an individual neuron to stimuli within its receptive field is approximated mathematically by a convolution operation. CNNs are based on biological processes and are variations of multilayer perceptrons designed to use minimal amounts of preprocessing.

In embodiments, the ML model 716 is a CNN that includes both convolutional layers and max pooling layers. For example, the architecture of the ML model 716 is “fully convolutional,” which means that variable sized sensor data vectors are fed into it. For convolutional layers, the ML model 716 specifies a kernel size, a stride of the convolution, and an amount of zero padding applied to the input of that layer. For the pooling layers, the model 716 specifies the kernel size and stride of the pooling.

In some embodiments, the ML system 700 trains the ML model 716, based on the training data 720, to correlate the feature vector 712 to expected outputs in the training data 720. As part of the training of the ML model 716, the ML system 700 forms a training set of features and training labels by identifying a positive training set of features that have been determined to have a desired property in question, and, in some embodiments, forms a negative training set of features that lack the property in question.

The ML system 700 applies ML techniques to train the ML model 716, that when applied to the feature vector 712, output indications of whether the feature vector 712 has an associated desired property or properties, such as a probability that the feature vector 712 has a particular Boolean property, or an estimated value of a scalar property. In embodiments, the ML system 700 further applies dimensionality reduction (e.g., via linear discriminant analysis (LDA), PCA, or the like) to reduce the amount of data in the feature vector 712 to a smaller, more representative set of data.

In embodiments, the ML system 700 uses supervised ML to train the ML model 716, with feature vectors of the positive training set and the negative training set serving as the inputs. In some embodiments, different ML techniques, such as linear support vector machine (linear SVM), boosting for other algorithms (e.g., AdaBoost), logistic regression, naïve Bayes, memory-based learning, random forests, bagged trees, decision trees, boosted trees, boosted stumps, neural networks, CNNs, etc., are used. In some example embodiments, a validation set 732 is formed of additional features, other than those in the training data 720, which have already been determined to have or to lack the property in question. The ML system 700 applies the trained ML model 716 to the features of the validation set 732 to quantify the accuracy of the ML model 716. Common metrics applied in accuracy measurement include Precision and Recall, where Precision refers to a number of results the ML model 716 correctly predicted out of the total it predicted, and Recall is a number of results the ML model 716 correctly predicted out of the total number of features that had the desired property in question. In some embodiments, the ML system 700 iteratively retrains the ML model 716 until the occurrence of a stopping condition, such as the accuracy measurement indication that the ML model 716 is sufficiently accurate, or a number of training rounds having taken place. In embodiments, the validation set 732 includes data corresponding to confirmed locations, dates, times, activities, or combinations thereof. This allows the detected values to be validated using the validation set 732. The validation set 732 is generated based on the analysis to be performed.

FIG. 8 is a block diagram illustrating an example computer system, in accordance with one or more embodiments. Components of the example computer system 800 are used to implement the smart radios 224, the cloud computing system 220, and/or other systems described herein. In some examples, the example computer system 800 is embodied by a tag/sensor unit that acts as a proximate device that provides contextual information to a nearby worker. At least some operations described herein are implemented on the computer system 800.

The computer system 800 includes one or more central processing units (“processors”) 802, main memory 806, non-volatile memory 810, network adapters 812 (e.g., network interface), video displays 818, input/output devices 820, control devices 822 (e.g., keyboard and pointing devices), drive units 824 including a storage medium 826, and a signal generation device 830 that are communicatively connected to a bus 816. The bus 816 is illustrated as an abstraction that represents one or more physical buses and/or point-to-point connections that are connected by appropriate bridges, adapters, or controllers. In embodiments, the bus 816, includes a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an IEEE standard 1394 bus (also referred to as “Firewire”).

In embodiments, the computer system 800 shares a similar computer processor architecture as that of a desktop computer, tablet computer, personal digital assistant (PDA), mobile phone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the computer system 800.

While the main memory 806, non-volatile memory 810, and storage medium 826 (also called a “machine-readable medium”) are shown to be a single medium, the term “machine-readable medium” and “storage medium” should be taken to include a single medium or multiple media (e.g., a centralized/distributed database and/or associated caches and servers) that store one or more sets of instructions 828. The term “machine-readable medium” and “storage medium” shall also be taken to include any medium that is capable of storing, encoding, or carrying a set of instructions for execution by the computer system 800.

In general, the routines executed to implement the embodiments of the disclosure are implemented as part of an operating system or a specific application, component, program, object, module, or sequence of instructions (collectively referred to as “computer programs”). The computer programs typically include one or more instructions (e.g., instructions 804, 808, 828) set at various times in various memory and storage devices in a computer device. When read and executed by the one or more processors 802, the instruction(s) cause the computer system 800 to perform operations to execute elements involving the various aspects of the disclosure.

Moreover, while embodiments have been described in the context of fully functioning computer devices, those skilled in the art will appreciate that the various embodiments are capable of being distributed as a program product in a variety of forms. The disclosure applies regardless of the particular type of machine or computer-readable media used to actually effect the distribution.

Further examples of machine-readable storage media, machine-readable media, or computer-readable media include recordable-type media such as volatile and non-volatile memory devices 810, floppy and other removable disks, hard disk drives, optical discs (e.g., Compact Disc Read-Only Memory (CD-ROMS), Digital Versatile Discs (DVDs)), and transmission-type media such as digital and analog communication links.

The network adapter 812 enables the computer system 800 to mediate data in a network 814 with an entity that is external to the computer system 800 through any communication protocol supported by the computer system 800 and the external entity. In embodiments, the network adapter 812 includes a network adapter card, a wireless network interface card, a router, an access point, a wireless router, a switch, a multilayer switch, a protocol converter, a gateway, a bridge, a bridge router, a hub, a digital media receiver, and/or a repeater.

In embodiments, the network adapter 812 includes a firewall that governs and/or manages permission to access proxy data in a computer network and tracks varying levels of trust between different machines and/or applications. In embodiments, the firewall is any number of modules having any combination of hardware and/or software components able to enforce a predetermined set of access rights between a particular set of machines and applications, machines and machines, and/or applications and applications (e.g., to regulate the flow of traffic and resource sharing between these entities). The firewall additionally manages and/or has access to an access control list that details permissions including the access and operation rights of an object by an individual, a machine, and/or an application, and the circumstances under which the permission rights stand.

In embodiments, the functions performed in the processes and methods are implemented in differing order. Furthermore, the outlined steps and operations are only provided as examples. For example, some of the steps and operations are optional, combined into fewer steps and operations, or expanded into additional steps and operations without detracting from the essence of the disclosed embodiments.

In embodiments, the techniques introduced here are implemented by programmable circuitry (e.g., one or more microprocessors), software and/or firmware, special-purpose hardwired (i.e., non-programmable) circuitry, or a combination of such forms. In embodiments, special-purpose circuitry is in the form of one or more application-specific integrated circuits (ASICs), programmable logic devices (PLDs), field-programmable gate arrays (FPGAs), etc.

The description and drawings herein are illustrative and are not to be construed as limiting. Numerous specific details are described to provide a thorough understanding of the disclosure. However, in certain instances, well-known details are not described in order to avoid obscuring the description. Further, various modifications can be made without deviating from the scope of the embodiments.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. It will be appreciated that the same thing can be said in more than one way. One will recognize that “memory” is one form of a “storage” and that the terms are on occasion used interchangeably.

Consequently, alternative language and synonyms are used for any one or more of the terms discussed herein, and no special significance is to be placed upon whether or not a term is elaborated or discussed herein. Synonyms for certain terms are provided. A recital of one or more synonyms does not exclude the use of other synonyms. The use of examples anywhere in this specification, including examples of any term discussed herein, is illustrative only and is not intended to further limit the scope and meaning of the disclosure or of any exemplified term. Likewise, the disclosure is not limited to various embodiments given in this specification.

I/We claim:

1. A method for improving creation of worksite data records with context-enhanced user dictation into a smart radio comprising:
receiving, by a computing device from a user, an audio utterance, wherein the audio utterance is stored as a digital audio recording by the computing device;
generating, by the computing device, a digital text file from the digital audio recording of the audio utterance;
identifying, by the computing device, a worksite context for the audio utterance, wherein the worksite context for the audio utterance is based on information surrounding the user when the audio utterance is recorded;
identifying, via an artificial intelligence (AI) model, a type of workflow record to generate for the audio utterance based on the digital text file; and
generating a workflow record vial the AI model corresponding to the identified type of workflow record, wherein the AI model populates a plurality of data fields of the workflow record using one or more of the digital text file, the worksite context for the audio utterance, or a current task of the user.

2. The method of claim 1, wherein the information surrounding the user when the audio utterance is recorded includes one or more of:
data corresponding to a geofence, wherein the geofence corresponds to a virtual perimeter or boundary defined using geographic coordinates;
location of devices proximate to the smart radio;
properties corresponding to devices proximate to the smart radio;
additional devices proximate to the smart radio;
user actions prior to the audio utterance;
a job of the user;
a role of the user; and
communications to the user received by the smart radio.

3. The method of claim 1, wherein the AI model populates the plurality of data fields of the workflow record further comprising:
segmenting, by the AI model, the digital text file into text strings, wherein each text string corresponds to a particular data field of the plurality of data fields; and
entering, by the AI model, the text strings into the plurality of data fields.

4. The method of claim 1, wherein the AI model is a natural language processing (NLP) model, further comprising:
determining, via the natural language processing (NLP) model, semantic gaps in the digital text file, wherein the NLP model corrects the semantic gaps in the audio utterance by adding additional text to the digital text file based on the identified worksite context for the audio utterance.

5. The method of claim 4, wherein the NLP model is configured to process the audio utterance, including determining and correcting the semantic gaps in the audio utterance, through one or more of:
a classification function in which the NLP model classifies portions of the audio utterance as being a semantic gap or not;
a bank of known words relating to a subject semantic gap; and
a training dataset of words, wherein a plurality of words in the training dataset are labeled as relating to semantic gaps.

6. The method of claim 1, wherein the computing device receives the audio utterance from the user further comprising:
recording, via a microphone of the computing device, the audio utterance; or
recording, via a recording device communicatively coupled to the computing device, the audio utterance, wherein the recording device transmits the audio utterance as the digital audio recording to the computing device.

7. The method of claim 1, wherein the AI model updates an existing workflow record corresponding to the identified type of workflow record, wherein the AI model populates the plurality of data fields of the existing workflow record using one or more of the audio utterance, the worksite context for the audio utterance, or the current task of the user.

8. The method of claim 1, wherein the computing device is a first computing device, further comprising:
detecting a presence of a second computing device; and
in response to detecting the presence, automatically transmitting a notification through a speaker of the first computing device prompting the user to provide an audio utterance.

9. The method of claim 8, wherein the second computing device is a sensor that monitors a status of a machine.

10. A system for improving creation of worksite data records with context-enhanced user dictation into a smart radio comprising:
at least one hardware processor; and
at least one non-transitory memory storing instructions, which, when executed by the at least one hardware processor, cause the system to:
receive an audio utterance from a user, wherein the audio utterance is stored as a digital audio recording by the smart radio;
generate a digital text file from the digital audio recording of the audio utterance;
identify a worksite context for the audio utterance, wherein the worksite context for the audio utterance is based on information surrounding the user when the audio utterance is recorded as detected by the smart radio;
identify, via an artificial intelligence (AI) model, a type of workflow record to generate for the audio utterance based on the digital text file; and
generate a workflow record via the AI model corresponding to the identified type of workflow record, wherein the AI model populates a plurality of data fields of the workflow record using one or more of the digital text file, the worksite context for the audio utterance, or a current task of the user.

11. The system of claim 10, wherein the information surrounding the user when the audio utterance is recorded includes one or more of:
data corresponding to a geofence, wherein the geofence corresponds to a virtual perimeter or boundary defined using geographic coordinates;
location of devices proximate to the smart radio;
properties corresponding to devices proximate to the smart radio;
additional devices proximate to the smart radio;
user actions prior to the audio utterance;
a job of the user;
a role of the user; and
communications to the user received by the smart radio.

12. The system of claim 10, wherein the AI model populates the plurality of data fields of the workflow record, further comprising:
segmenting, by the AI model, the digital text file into text strings, wherein each text string corresponds to a particular data field of the plurality of data fields; and
entering, by the AI model, the text strings into the plurality of data fields.

13. The system of claim 10, wherein the AI model is a natural language processing (NLP) model, further comprising:
determining, via the natural language processing (NLP) model, semantic gaps in the digital text file, wherein the NLP model corrects the semantic gaps in the audio utterance by adding additional text to the digital text file based on the identified context for the audio utterance.

14. The system of claim 13, wherein the NLP model is configured to process the audio utterance, including determining and correcting the semantic gaps in the audio utterance, through one or more of:
a classification function in which the NLP model classifies portions of the audio utterance as being a semantic gap or not;
a bank of known words relating to a subject semantic gap; and
a training dataset of words, wherein a plurality of words in the training dataset are labeled as relating to semantic gaps.

15. The system of claim 10, wherein the smart radio receives the audio utterance from the user is further configured to:
record the audio utterance with a microphone of the smart radio.

16. The system of claim 10, wherein the smart radio updates an existing workflow record corresponding to the identified type of workflow record, wherein the AI model populates the plurality of data fields of the existing workflow record using one or more of the audio utterance, the worksite context for the audio utterance, or the current task of the user.

17. The system of claim 10, wherein the smart radio, in response to detecting a presence of an external device, automatically transmits a notification through a speaker of the smart radio prompting the user to provide an audio utterance.

18. The system of claim 17, wherein the external device is a sensor that monitors a status of a machine.

19. A method for improving creation of worksite data records with context-enhanced user dictation into a smart radio comprising:
receiving, by a smart radio from a user, an audio utterance, wherein the audio utterance is stored as a digital audio recording by the smart radio;
generating, by the smart radio, a digital text file from the digital audio recording of the audio utterance;
identifying, by the smart radio, a worksite context for the audio utterance, wherein the worksite context for the audio utterance is based on information surrounding the user when the audio utterance is recorded;
identifying, via an artificial intelligence (AI) model, an existing workflow record to update based on the digital text file; and
updating the existing workflow record via the AI model, wherein the AI model populates a plurality of data fields of the existing workflow record using one or more of the digital text file, the worksite context for the audio utterance, or a current task of the user.

20. The method of claim 19, wherein the information surrounding the user when the audio utterance is recorded includes one or more of:
data corresponding to a geofence, wherein the geofence corresponds to a virtual perimeter or boundary defined using geographic coordinates;
location of devices proximate to the smart radio;
properties corresponding to devices proximate to the smart radio;
additional devices proximate to the smart radio;
user actions prior to the audio utterance;
a job of the user;
a role of the user; and
communications to the user received by the smart radio.

21. The method of claim 19, wherein the AI model populates the plurality of data fields of the existing workflow record further comprising:
segmenting, by the AI model, the digital text file into text strings, wherein each text string corresponds to a particular data field of the plurality of data fields; and
entering, by the AI model, the text strings into the plurality of data fields.

22. The method of claim 19, wherein the AI model is a natural language processing (NLP) model, further comprising:
determining, via the natural language processing (NLP) model, semantic gaps in the digital text file, wherein the NLP model corrects the semantic gaps in the audio utterance by adding additional text to the digital text file based on the identified worksite context for the audio utterance.

23. The method of claim 22, wherein the NLP model is configured to process the audio utterance, including determining and correcting the semantic gaps in the audio utterance, through one or more of:
a classification function in which the NLP model classifies portions of the audio utterance as being a semantic gap or not;
a bank of known words relating to a subject semantic gap; and
a training dataset of words, wherein a plurality of words in the training dataset are labeled as relating to semantic gaps.

24. The method of claim 19, wherein the smart radio receives the audio utterance from the user further comprising:
recording, via a microphone of the smart radio, the audio utterance.

25. The method of claim 19, wherein the smart radio automatically transmits a notification through a speaker of the smart radio prompting the user to provide and audio utterance in response to detecting a presence of a computing device.

26. The method of claim 25, wherein the computing device is a sensor that monitors a status of a machine.
